(19) United States
(12) Patent Application Publication
(10) Pub. No.: US 2018/0325135 A1
(43) Pub. Date: Nov. 15, 2018

(54) EDIBLE MORPHOLINE-FREE COATING FORMULATIONS

(71) Applicant: Yissum Research Development Company of the Hebrew University of Jerusalem Ltd., Jerusalem (IL)

(72) Inventors: Amos NUSSINOVITCH, Rehovot (IL); Haim David RABINOWITCH, Kiryat Ono (IL)

(73) Assignee: Yissum Research Development Company of the Hebrew University of Jerusalem Ltd., Jerusalem (IL)

(21) Appl. No.: 15/531,040

(22) PCT Filed: Nov. 29, 2015
(86) PCT No.: PCT/IL2015/051163

§ 371 Date: May 26, 2017

Related U.S. Application Data
(60) Provisional application No. 62/085,570, filed on Nov. 30, 2014.

(51) Int. Cl. A23B 7/16; C09D 105/04; C09D 7/63; C09D 7/61

(52) U.S. Cl. CPC A23B 7/16; C09D 105/04; A23V 2002/00; C09D 7/61; C09D 7/63

(57) ABSTRACT

Provided are coating compositions for, and methods for reducing weight loss and improving the shelf life of, post-harvest edible and non-edible plant matter. In particular, the compositions may include a hydrocolloid polymer, an edible wax, a fatty acid, an edible alkaline component essentially free of morpholine and/or ammonia, and water. The edible alkaline component allows formation of a homogeneous emulsion without the need for any additional emulsifier. The methods include applying the compositions to the surface of plant matter, and more specifically to plant matter having a natural skin, shell or tunic.

### FIELD OF THE INVENTION

The present invention relates to compositions and methods for coating of plants, either edible, medicinal, or ornamental, which are particularly useful for minimizing postharvest losses of plant weight and preventing or slowing down post-harvest reduction in quality.

### BACKGROUND OF THE INVENTION

Edible coatings have been employed for over 800 years to extend the shelf life of foods. In the United States, wax coatings have been utilized commercially since 1930s, when oranges were coated with melted paraffin waxes. These early coatings were used to further improve the appearance of the waxy glossy skin. The development of wax coatings was aimed to mimic the natural coatings of fruits and vegetables. Such coatings were also reported to reduce water losses and oxygen diffusion, thus lowering respiration rate and withering, and extending shelf life of the coated produce. However, the reduced respiratory gas exchange leads to fermentation, with the consequent buildup of ethanol, other volatiles, and bitter flavors [Sinclair, W. B., (1984), The Biochemistry and Physiology of the Lemon. University of California Division of Agriculture and Natural Resources: Oakland, Calif.]. Additional drawbacks of present day wax coatings are their structural instability, generally requiring a support matrix.

Alternative common coating compositions are gelation solutions and hydrocolloids. Acceptable surface coating made of such materials depends on cross-linking of the hydrocolloid by a solution of a gelation-inducing agent.

E.P. Patent No. 277448 discloses the formation of an edible coating made of gelatin and polysaccharide that depends on cross-linking agents containing calcium ions-.

U.S. Pat. Nos. 6,299,915 and 6,068,867, to some of the inventors of the present invention, disclose a hydrocolloid protective coating for food and other agricultural products comprised of dried hydrocolloid gel, one or more natural compounds isolated from the surface of said product or a compound substantially equivalent thereto, and other optional additives. These coatings improve the protection of the product, thereby extending its shelf-life.

Although hydrocolloid coatings form a good barrier that attenuates the exchange of oxygen and carbon dioxide with the environment, and has good mechanical properties, they do not sufficiently attenuate the passage of water vapors, thereby failing to reduce transpiration and consequently continuous weight loss of the coated organs and shriveling thereof.

Several attempts have been made to develop coating materials that potentially modify internal gas composition for short-term storage [H. J. Park, Trends in Food Science & Technology 10 (1999) 254-260]. For Example, U.S. Pat. Nos. 7,771,763 and 7,169,423 disclose edible compositions comprised of chitosan polymer.

Composite coating compositions are made of a mixture of waxes and hydrocolloids, where the aim is to take advantage of the beneficial properties of each chemical group and compensate for their disadvantages. In general, waxes efficiently block water vapor diffusion and provide glossy appearance. In turn, the hydrocolloids enable selective permeability to carbon dioxide and oxygen and the required mechanical properties of the coating.

International Patent Application Publ. No. WO 2013/144961 to one of the inventors of the present invention is directed to compositions and methods for reducing the weight loss and/or preserving the natural gloss of post-harvest edible plant matter, the methods comprising applying to the surface of the plant matter a composition comprising an edible wax having a melting temperature below 70° C.; a hydrocolloid; a fatty acid; an emulsifier; and water, wherein said edible wax is present in a weight percent ranging from about 10% to about 25% of the total weight of the composition.

U.S. Patent application No. 2004/0146617 and U.S. Pat. No. 7,222,455 disclose methods for suppressing cracking, stem browning, and water losses in vegetables or fruit, such as cherries. The methods include application of wax emulsion made of complex hydrocarbons, one or more emulsifying agents, and water. In some embodiments, the wax emulsion comprises from about 0.125% to about 25% (weight/weight) of carnauba wax, from about 0.1% to about 16% (weight/weight) of oleic acid, and from about 0.03% to about 6% (weight/weight) of morpholine, and from about 53% to about 99.7% (weight/weight) of water.

Morpholine O(CH₂CH₂)₂NH is an organic compound commonly used as an emulsifier in the process of waxing and/or coating of fresh fruits and vegetables. Morpholine is frequently added to certain waxes as morpholine oleate when fruits such as apple, citrus and pineapple are being coated. Morpholine oleate easily mixes with waxes and facilities their even spread and smooth appearance. Morpholine also facilitates the solubilization of shellac, one of the waxy constituents of fruit coating. Additionally, morpholine enables application of wax containing coating materials in a water-based liquid form. When the coating material is dried by a blow of hot air, the residual morpholine evaporates but for minute traces.

In addition to its important role in fruit and vegetables' coating, morpholine is widely used in the USA, Canada, Australia and elsewhere as a food additive. However, in the European Union, the use of morpholine and of other amine containing emulsifiers is prohibited.

In foods, nitrites are formed mainly from naturally-occurring nitrates. In the presence of excess nitrites, morpholine can be chemically modified (nitrosated) to form N-nitrosomorpholine (NMOR), a genotoxic carcinogen in rodents. While morpholine by itself does not pose health concerns, the main apprehension is whether NMOR are produced upon ingestion by humans, in amounts that may pose a health risk. Under European Union food additives legislation (EC Regulation 1333/2008), morpholine is barred from use for glazing fresh fruits. Hence, morpholine treated produce is banned from marketing and sale in the EU—a fact well known in countries where its use is permitted. Consequently, the latter apply strict protocols guaranteeing that fruit coated with morpholine containing waxes are not destined for the EU.

Several morpholine-free water-based wax compositions for food coating were developed to date. Hagenmaier et al. disclose edible coatings containing ammonia instead of morpholine [R. D. Hagenmaier, R. A. Baker, J. Agric. Food Chem. 1997, 45, 349-352].

Like morpholine, the alkaline ammonia “acts as a cation in aqueous solution but evaporates as the coating dries” [R. D. Hagenmaier, Proc. Fla. State Hort. Soc. 117; 396-402, 2004]. Therefore, ammonia meets the chemical demands of the coating composition. However, ammonia evaporates very rapidly (boiling point 37° C.), especially at the high temperatures (about 95° C.) required for the formulation of, for example, carnauba wax micro-emulsions. Even at ambient temperatures, ammonia evaporates from coating formulations fast enough to make it necessary to keep them tightly closed. Ammonia vapor is unpleasant, toxic and, in addition, can cause false alarms of ammonia-based refrigeration system leakage, for example, in packing houses.

Edible coatings have been reported to be effective for various kinds of fruits and vegetables. However, little is known on edible coatings on plant protected by an outer natural layer or tunic of leaf scales, such as in garlic and onion bulbs. Harvested on maturation, garlic bulbs are stored at either ambient conditions or cold rooms. Either way, life activities of the living tissues (storage tissues, meristems and regeneration buds) go on, including respiration and energy consumption during cell division, differentiation and elongation. Additionally, water is lost by evaporation and transpiration. Some genotypes tend to lose their tunics, thus further facilitating transpiration, invasion of pests, wounding, susceptibility to mechanical bruises, and in the case of garlic, even breaking of the bulbs to individual cloves. Transpiration from dry bulbs and respiration (consumption of reserves) result in a significant weight losses. Biochemical processes such as breakdown of various chemicals with consequent reduction in quality (including chemicals that allow for Maillard reactions, e.g., reserves such as fructans and starch to monosaccharides) dry out the skins with the consequent loss of skins. Moreover, quality is reduced when bulbs shrivel and/or suffer bruises and breakups with the consequent rejection by wholesalers, retailers and consumers. In addition, pest infection leads to a significant reduction in quality, in rotting, and in accumulation of mycotoxins such as fumonisin excreted by microorganisms such as Fusarium proliferatum.

Geraldine et al. (2008) described minimally processed garlic cloves coated by 1% agar-agar based compositions comprising of 0.2% chitosan and 0.2% acetic acid [R.M. Geraldine et al./Carbohydrate Polymers 72 (2008) 403-409]. Nussinovitch et al. (1996) described garlic bulbs coating by immersion in a food grade sodium alginate solution followed by application of calcium chloride dissolved in water [A. Nussinovitch et. al, Volume 61, No. 4, 1996 J. Food Sci. 769].

U.S. Pat. No. 3,865,962 discloses a process for coating bulb onions by immersion in an aqueous alginate solution with subsequent gelation by treatment with an aqueous calcium ion.

It would be advantageous to have composite compositions made of wax-hydrocolloid mixtures, providing superior protection against weight losses and mechanical stability properties, thus reducing mechanical damages, for coating geophytes such as garlic and onion.

There remains an unmet need in the art for edible coating compositions, free of morpholine, for shelf-life extension of the post-harvest plant matter, wherein such composition can be applied to various plants, including those having natural tunics.

### SUMMARY OF THE INVENTION

The present invention provides safe, edible coating compositions including a hydrocolloid, an edible wax, a fatty acid and an edible alkaline component. These novel coating compositions are useful for coating plant matter and thereby reduce the plant's postharvest water losses, weight and quality reduction. Moreover, the compositions reduce mechanical damages and provide a defense layer against the penetration of and infection with pests. The present invention is based in part on the unexpected finding that potentially toxic amine containing emulsifiers, such as morpholine, can be successfully replaced by edible alkaline components.

More specifically, compositions according to the present invention were found to be particularly beneficial when applied to garlic and onions, whose bulbs are naturally coated with tunics made of the oldest leaves' sheaths. Surprisingly, compositions according to the principles of the present invention reduced the weight loss of coated clonally propagated garlic bulbs by about 47% over about three months as compared to the non-coated garlic, and by about 40% as compared to the garlic coated by similar compositions comprising morpholine Similarly, the weight loss of post-harvest onion bulbs coated by compositions of the present invention was reduced by about 23% over about three months as compared to the non-coated onion bulbs of the same variety, from the same field harvested in tandem with the bulk of the coated bulbs. The coating compositions of the present invention were also applied to peppers, eggplants, and tomatoes, showing a significant reduction in weight losses as compared to the uncoated fruit.

The present invention provides, in one aspect, a composition for coating a postharvest plant matter, comprising a hydrocolloid polymer; an edible wax; a fatty acid; water; and an edible alkaline component essentially free of morpholine and/or ammonia; wherein the edible alkaline component enables a homogeneous emulsion without any additional emulsifier. In some embodiments, the composition for coating a postharvest plant matter comprises a hydrocolloid polymer; an edible wax; a fatty acid; water; and an edible alkaline component; characterized in that the edible alkaline component is essentially free of amines

In some embodiments, the edible alkaline component is an inorganic alkaline component. In further embodiments, the inorganic alkaline component is an inorganic alkaline salt. In further embodiments, the inorganic alkaline component is an alkali metal salt or an alkaline earth metal salt. In certain such embodiments, the edible inorganic alkaline component is selected from the group consisting of sodium hydroxide (NaOH), potassium hydroxide (KOH) sodium carbonate (Na₂CO₃), potassium carbonate (K₂CO₃), sodium bicarbonate (NaHCO₃), potassium bicarbonate (KHCO₃) and any combination thereof. Each possibility represents a separate embodiment of the present invention. In some embodiments, the edible alkaline component is present in a weight percent ranging from about 0.05% to about 2% of the total weight of the wet composition. In other embodiments, the edible alkaline component is present in a weight percent ranging from about 1% to about 30% of the total weight of the dry composition.

The hydrocolloid polymer can be selected from gelling hydrocolloids, non-gelling colloids and combinations thereof. In certain embodiments, the hydrocolloid polymer is selected from the group consisting of alginate, agar, agarose, gelatin, low methoxy pectin (LMP), chitosan, gellan, carrageenan, locust bean gum (LBG), guar gum and mixtures thereof. Each possibility represents a separate embodiment of the invention. In a specific embodiment, the hydrocolloid polymer is alginate. In another specific embodiment, the hydrocolloid polymer is guar gum. In a further specific embodiment, the hydrocolloid polymer is locust bean gum. In certain embodiments, the hydrocolloid polymer is present in a weight percent ranging from about 0.5% to about 5% of the total weight of the wet composition. In certain such embodiments, the hydrocolloid polymer is present in a weight percent of about 1% or about 2% of the total weight of the wet composition. In certain embodiments, the hydrocolloid polymer is present in a weight percent ranging from about 20% to about 60% of the total weight of the dry composition.

In certain embodiments, the edible wax is selected from the group consisting of beeswax, carnauba wax, candelilla wax, alpha wax, montan wax, rice-bran wax, Japan wax and mixtures thereof. Each possibility represents a separate embodiment of the present invention. In certain embodiments, the edible wax has a melting temperature above ambient temperatures but lower than about 70° C. In further embodiments, the edible wax has a melting temperature between about 40° C. and about 70° C. In a specific embodiment, the edible wax is beeswax. In certain embodiments, the edible wax is present in a weight percent ranging from about 5% to about 50% of the total weight of the wet composition. In additional embodiments, the edible wax is present in a weight percent ranging from about 0.1% to about 5% of the total weight of the wet composition. In certain embodiments, the edible wax is present in a weight percent ranging from about 2% to about 35% of the total weight of the dry composition. Each possibility represents a separate embodiment of the present invention.

In certain embodiments, the fatty acid is selected from the group consisting of oleic acid, stearic acid, palmitic acid, lauric acid, myristic acid, behenic acid, isostearic acid, and mixtures thereof. Each possibility represents a separate embodiment of the present invention. In a specific embodiment, the fatty acid is oleic acid. In some embodiments, the fatty acid is present in a weight percent ranging from about 0.01% to about 2% of the total weight of the wet composition. In other embodiments, the fatty acid is present in a weight percent ranging from about 1% to about 40% of the total weight of the dry composition.

In some embodiments, the composition for coating a postharvest plant matter is stable at ambient conditions for at least about one month. In some embodiments, the composition for coating a postharvest plant matter is stable at cold storing conditions for at least about one month.

In certain embodiments, the postharvest plant matter is selected from edible plant matter, plant organ and/or plant tissue. The terms “plant matter”, “plant organ” or “plant tissue” are used herein interchangeably. In certain embodiments, the edible plant matter is selected from the group consisting of a fruit and a vegetable having an external skin layer or layers. In certain embodiments the edible plant matter is selected from the group consisting of a fruit and a vegetable coated with protective skin. In specific exemplary embodiments, the edible plant matter comprises garlic or onion bulbs. In other specific exemplary embodiments, the edible plant matter comprises pepper or eggplants. In further specific exemplary embodiments, the edible plant matter comprises tomatoes. Each possibility represents a separate embodiment of the present invention. In some embodiments, the composition is formulated to provide an artificial coating to the postharvest plant matter having a skin.

In certain embodiments, the composition further comprises a natural compound isolated from the surface of said plant matter or a compound substantially equal thereto. In certain embodiments, said compound is a sterol, selected from the group consisting of β-sitosterol, ergosterol, sigmaterol and mixtures thereof. Each possibility represents a separate embodiment of the present invention. In a specific embodiment, said compound is β-sitosterol. In another specific embodiment, said compound is quercetin.

In certain embodiments, the composition further comprises an ethylene retarding agent, such as, but not limited to silver salts, (e.g., silver nitrate, or silver thiosulfate), gibberellins, 2,5-norbomadiene, or trans-cy-dooctene. Each possibility represents a separate embodiment of the present invention.

In some embodiments, the composition further comprises anti-gibberellin compounds, including but not limited to onium compounds; compounds with an N-containing heterocycle; structural mimics of 2-oxoglutaric acid or acyl cyclohexanediones. Specific examples of anti-gibberellin compounds include 16,17-dihydro-gibberellin A5 and derivatives thereof; ethephon (2-chloroethylphosphonic acid) and other ethylene releasing compounds.

In further embodiments, the coating composition comprises about 0.5%-5% (w/w) of hydrocolloid polymer; about 0.1%-5% (w/w) of edible wax; about 0.01%-2% (w/w) of fatty acid; about 0.05%-2% (w/w) of edible alkaline component; and about 83%-99% water, of the total weight of the wet composition. In still further embodiments, the coating composition comprises about 20%-60% (w/w) of hydrocolloid polymer; about 2%-35% (w/w) of edible wax; about 1%-40% (w/w) of fatty acid; about 1%-30% (w/w) of edible alkaline component; and about 4%-30% water, of the total weight of the dry composition. In particular embodiments, the hydrocolloid is alginate. In other particular embodiments, the edible wax is beeswax. In further particular embodiments, the fatty acid is oleic acid. In additional particular embodiments, the edible alkaline component is potassium hydroxide.

In some embodiments, the composition is for use in combination with a composition comprising a cross-linking and/or a gelation-inducing agent. In certain such embodiments, the hydrocolloid polymer is a gelling hydrocolloid. According to particular embodiments, the hydrocolloid polymer is alginate. In certain embodiments, the composition further comprises a cross-linking and/or a gelation-inducing agent. In further embodiments, the composition for coating a post-harvest plant matter and the composition comprising a cross-linking and/or a gelation-inducing agent are present in separate containers. According to some embodiments, there is provided a kit comprising the composition for coating a post-harvest plant matter and the composition comprising a cross-linking and/or a gelation-inducing agent, in separate containers. In some embodiments, a cross-linking and/or a gelation inducing agent comprises calcium (Ca⁺⁺), magnesium (Mg⁺⁺), barium (Ba⁺⁺), ferrous (Fe⁺⁺) and/or aluminum(Al⁺⁺⁺) ions. In further embodiments, a cross-linking and/or a gelation-inducing agent comprise calcium or barium ions. Each possibility represents a separate embodiment of the invention.

In another aspect, the present invention relates to a method for reducing the weight loss of a post-harvest plant matter by providing an artificial skin/coating, comprising the application to the surface of the plant matter a composition comprising a hydrocolloid polymer; an edible wax; a fatty acid; water; and an edible alkaline component essentially free of morpholine and/or ammonia; wherein the edible alkaline component allows formation of a homogeneous emulsion without the need for any additional emulsifier, thereby coating the plant matter with said composition.

In certain embodiments, the composition is applied by dipping the plant matter into said composition. In further embodiments, the composition is applied by brushing or by rubbing the composition onto the plant matter surface. In yet further embodiments, the composition is applied by spraying, showering, drenching and/or enrobing. Each possibility represents a separate embodiment of the invention.

In certain embodiments, the method further comprises the steps of allowing the excess composition to drip from the plant matter; and drying the coating of the plant matter. In particular embodiments, the method comprises the step of applying to the plant matter additional composition comprising cross-linking or gelation inducing agents. In certain such embodiments, the hydrocolloid polymer is a gelling hydrocolloid. According to particular embodiments, the hydrocolloid polymer is alginate.

According to some embodiments, the composition is applied to the plant matter in a volume of from about 0.5 μl to about 500 μl per about 100 g of the plant matter. According to certain embodiments, the volume of the applied composition is from about 5 μl to about 25 μl.

In another aspect, there is provided a coating composition comprising a formulation selected from Formulations 9-11, 13-21 and 23-24 described in Table 1 and Formulations 26, 27 and 32 described in Table 3, and any combination thereof.

In another aspect, there is provided a postharvest plant matter, coated with an edible coating comprising a hydrocolloid polymer; an edible wax; a fatty acid; and an edible alkaline component essentially free of morpholine and/or ammonia. According to some embodiments, the edible coating further comprises water. According to particular embodiments, the water is present in the coating in a weight percent of up to about 30%.

In some embodiments, the hydrocolloid polymer is present in the coating in a weight percent ranging from about 20% to about 60% of the total weight of the coating. In some embodiments, the edible wax is present in the coating in a weight percent ranging from about 2% to about 35% of the total weight of the coating. In some embodiments, the fatty acid is present in the coating in a weight percent ranging from about 1% to about 40% of the total weight of the coating. In some embodiments, the edible alkaline component is present in the coating in a weight percent ranging from about 1% to about 30% of the total weight of the coating. In certain embodiments, the coating comprises about 20%-60% (w/w) of hydrocolloid polymer; about 2%-35% (w/w) of edible wax; about 1%-40% (w/w) of fatty acid; about 1%-30% (w/w) of edible alkaline component; and about 4%-30% water, of the total weight of the coating.

According to some embodiments, the thickness of the coating is from about 0.1 μm to about 10 μm. According to the currently preferred embodiments, the thickness of the coating is from about 0.5 μm to about 5 μm.

In another aspect, there is provided a gas-permeable coating composition for preventing and/or retarding food spoilage, the composition comprising a hydrocolloid polymer; an edible wax; a fatty acid; water; and an edible alkaline component essentially free of morpholine and/or ammonia, wherein the edible alkaline component enables a homogeneous emulsion without any additional emulsifier. In some embodiments, the gas-permeable coating composition comprises a hydrocolloid polymer; an edible wax; a fatty acid; water; and an edible alkaline component, wherein the edible alkaline component is essentially free of amines.

Further embodiments and the full scope of applicability of the present invention will become apparent from the detailed description given hereinafter. However, it should be understood that the detailed description and specific Examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1A is a graph depicting temporal weight losses in fresh garlic bulbs in storage. Changes in weight of control, non-treated garlic bulbs were compared with those of coated garlic bulbs treated with comprising either morpholine or ammonia. Non-coated (♦), coated with Formulation #1 (▴), coated with Formulation #2 (×), coated with Formulation #3 (*).

FIG. 1B shows the actual garlic bulbs used for assays as described in FIG. 1A. (Top left)—Non-coated, (Bottom left)—coated with Formulation #1, (Top right)—coated with Formulation #2, (Bottom right)—coated with Formulation #3.

FIG. 2 is a graph depicting the weight change of garlic bulbs in storage with time. Temporal fresh weight measurements of non-treated garlic bulbs were compared with garlic bulbs coated by compositions comprising of beeswax and ammonia at different concentrations, with or without β-sitosterol. All compositions were applied by rubbing onto the external skins of the garlic bulbs. Non-coated (♦), coated with Formulation #2 (▪), coated with Formulation #4 (▴), coated with Formulation #5 (×), coated with Formulation #6 (*), coated with Formulation #7 (•), coated with Formulation #8 (+).

FIG. 3 is a graph depicting the weight change of garlic bulbs in storage as a function of time. Weight losses of control, non-coated garlic bulbs were compared with garlic bulbs coated by compositions comprising ammonia, NaOH, KOH or Na₂CO₃. All coating compositions were adjusted to pH 7.5. Non-coated (♦), coated with Formulation #2 (▪), coated with Formulation #9 (▴), coated with Formulation #10 (×), coated with Formulation #11 (*).

FIG. 4A is a graph depicting the weight loss of garlic bulbs in storage as a function of time. Garlic bulbs with no coating were compared with garlic bulbs coated by compositions comprising morpholine, ammonia, NaOH, KOH or Na₂CO₃. Non-coated (♦), coated with Formulation #2 (▪), coated with Formulation #9 (▴), coated with Formulation #10 (×), coated with Formulation #11 (*), coated with Formulation #1 (•).

FIG. 4B shows the actual garlic bulbs treated as in FIG. 4A. (Top left)—Non-coated, (Top middle)—coated with Formulation #9, (Top right)—coated with Formulation #10, (Bottom left)—coated with Formulation #2, (Bottom right)—coated with Formulation #11.

FIG. 5 is a graph depicting the weight loss of garlic bulbs in storage as a function of time. Changes in fresh weight of control, non-coated garlic bulbs were compared with those of coated garlic bulbs coated by compositions comprising ammonia or KOH, with or without β-sitosterol. Non-coated (♦), coated with Formulation #12 (▪), also coated with Formulation #12 (▴), coated with Formulation #13 (×), coated with Formulation #14 (*).

FIG. 6 is a graph depicting the weight loss of garlic bulbs in storage as a function of time. Changes of fresh weight of non-coated garlic bulbs were compared with garlic bulbs coated by compositions comprising a variety of fatty acids. Non-coated (♦), coated with Formulation #10 (▪), coated with Formulation #15 (▴), coated with Formulation #16 (×), coated with Formulation #17 (*).

FIG. 7A is a graph depicting the weight loss of stored bulb onions under ambient room conditions in storage as a function of time. Changes in fresh weight of non-treated bulb onions were compared with stored bulb onions under ambient room conditions coated by compositions comprising ammonia, NaOH, KOH or Na₂CO₃. Non-coated (♦), coated with Formulation #2 (▪), coated with Formulation #9 (▴), coated with Formulation #10 (×), coated with Formulation #11 (*).

FIG. 7B shows the actual bulb onions treated as in of FIG. 7A. (Top left)—Non-coated, (Top right)—coated with Formulation #2, (Bottom left)—coated with Formulation #9, (Bottom middle)—coated with Formulation #10, (Bottom right)—coated with Formulation #11.

FIG. 8A is a graph depicting the weight loss of stored bulb onions under ambient room conditions as a function of time. Changes in fresh weight of control non-coated bulb onions were compared with stored bulb onions under ambient room conditions coated by compositions comprising different amounts of beeswax, with or without β-sitosterol. Non-coated (♦), coated with Formulation #18 (▪), coated with Formulation #19 (▴), coated with Formulation #20 (×), coated with Formulation #21 (*).

FIG. 8B shows the actual bulb onions described in FIG. 8A. (Top left)—coated with Formulation #20, (Top right)—coated with Formulation #21, (Bottom left)—coated with Formulation #18, (Bottom right)—coated with Formulation #19.

FIG. 9 is a graph depicting the weight loss of bulb onion as a function of time. Changes of fresh weight of control non-coated bulb onions were compared with those of stored bulb onions under ambient room conditions coated by compositions comprising KOH or ammonia, with or without β-sitosterol. Non-coated (♦), coated with Formulation #22 (▪), coated with Formulation #12 (▴), coated with Formulation #13 (×).

FIG. 10A is a graph depicting the weight loss of bulb onion as a function of time. Losses in fresh weights of non-coated bulb onions were compared with those of bulb-onions coated by compositions comprising beeswax at a variety of concentrations. Prior to storage, freshly harvested cure bulb onions were coated by dipping in the designated coating composition solutions. Non-coated (♦), coated with Formulation #21 (▪), coated with Formulation #23 (▴), coated with Formulation #24 (×).

FIG. 10B is a picture of the actual bulb onions treated as described in FIG. 10A. (Left)—Non-coated, (Second to left)—coated with Formulation #21, (Second to right)—coated with Formulation #23, (Right)—coated with Formulation #24.

FIG. 11A is a graph depicting the weight loss of stored bulb onions as a function of time. The weight changes of non-coated bulb onions were compared with those of bulb onions coated by compositions comprising different amounts of beeswax, as in FIG. 10A. Prior to storage, freshly harvested cure bulb onions were coated by dipping in coating composition solutions. Non-coated (♦), coated with Formulation #21 (▪), coated with Formulation #23 (▴), coated with Formulation #24 (×).

FIG. 11B shows the actual treated bulb onions described in FIG. 11A. (Left)—Non-coated, (Second to left)—coated with Formulation #21, (Second to right)—coated with Formulation #23, (Right)—coated with Formulation #24.

FIG. 12A is a graph depicting the weight loss of stored bulb onions as a function of time. Losses in fresh weights of control, non-coated bulb onions were compared with those of bulb onions coated by compositions comprising different amounts of beeswax. Prior to storage, freshly harvested cure bulb onions were coated by dipping in coating composition solutions. Non-coated (♦), coated with Formulation #21 (▪), coated with Formulation #24 (▴), coated with Formulation #25 (×).

FIG. 12B shows the actual bulb onions of FIG. 12A. (Left)—Non-coated, (Second to left)—coated with Formulation #21, (Second to right)—coated with Formulation #24, (Right)—coated with Formulation #25.

FIG. 13 is a graph depicting the weight loss of stored peppers as a function of time. Losses in fresh weights of control, non-coated peppers were compared with peppers coated by a composition comprising KOH. Prior to storage, freshly harvested cure peppers were coated by dipping in a coating composition solution. Non-coated (▪) and coated with Formulation #26 (▴).

FIG. 14 is a graph depicting the weight loss of stored peppers as a function of time. Losses in fresh weights of control, non-coated peppers were compared with peppers coated by compositions comprising different amounts of beeswax and oleic acid. Prior to storage, freshly harvested cure peppers were coated by dipping in coating composition solutions. Non-coated (♦), coated with Formulation #27 (▴), coated with Formulation #28 (×), and coated with Formulation #29 (▪).

FIG. 15 is a graph depicting the weight loss of stored peppers as a function of time. Losses in fresh weights of control, non-coated peppers were compared with peppers coated by compositions comprising different hydrocolloid polymers (LBG or CMC). Prior to storage, freshly harvested cure peppers were coated by dipping in coating composition solutions. Non-coated (♦), coated with Formulation #27 (▪) and coated with Formulation #30 (▴).

FIG. 16 is a graph depicting the weight loss of stored peppers as a function of time. Losses in fresh weights of control, non-coated peppers were compared with peppers coated by compositions comprising different hydrocolloid polymers (LBG or guar gum) at a variety of concentrations. Prior to storage, freshly harvested cure peppers were coated by dipping in coating composition solutions. Non-coated (♦), coated with Formulation #27 (▪), coated with Formulation #31 (▴) and coated with Formulation #32 (•).

FIG. 17 is a graph depicting the weight loss of stored eggplants as a function of time. Losses in fresh weights of control, non-coated eggplants were compared with eggplants coated by compositions comprising morpholine or KOH. Prior to storage, freshly harvested cure eggplants were coated by dipping in coating composition solutions. Non-coated (♦), coated with Formulation #27 (▴) and coated with Formulation #33 (▪).

FIG. 18 is a graph depicting the weight loss of stored eggplants as a function of time.

Losses in fresh weights of control, non-coated eggplants were compared with eggplants coated by compositions comprising different hydrocolloid polymers (LBG or CMC). Prior to storage, freshly harvested cure eggplants were coated by dipping in coating composition solutions. Non-coated (♦), eggplant coated with Formulation #27 (▪), the pedicel of an eggplant coated with Formulation #27 (•), the eggplant without a pedicel coated with Formulation #27 (∘), eggplant coated with Formulation #30 (Δ), the pedicel of an eggplant coated with Formulation #30 (▴) and the eggplant without a pedicel coated with Formulation #30 (×).

FIG. 19 is a graph depicting the weight loss of stored eggplants as a function of time. Losses in fresh weights of control, non-coated eggplants were compared with eggplants coated by compositions comprising different hydrocolloid polymers (LBG or Guar gum) at a variety of concentrations. Prior to storage, freshly harvested cure eggplants were coated by dipping in coating composition solutions. Non-coated (♦), coated with Formulation #27 (•), coated with Formulation #31(▴) and coated with Formulation #32 (▪).

FIG. 20 is a graph depicting the weight loss of stored tomatoes as a function of time. Losses in fresh weights of control, non-coated tomatoes (▴) were compared with tomatoes coated by Formulation #27 (▪).

### DETAILED DESCRIPTION OF THE INVENTION

The present invention encompasses edible hydrocolloid-wax based compositions useful for coating a plant matter, the compositions comprising an edible alkaline component essentially free of morpholine and/or ammonia, which eliminates the need for any additional emulsifier and/or makes the use of the additional emulsifier redundant. The coating composition of the present invention extends the shelf life of a plant matter coated with the composition by maintaining quality and reducing weight losses by reducing the plant's postharvest water loss or reducing dry matter loss due to respiration and/or modifying the composition of the internal atmosphere of the plant matter. According to some embodiments, the coating composition is suitable for providing a gas-permeable coating for preventing and/or retarding food spoilage.

Thus, according to one aspect there is provided a composition for coating a postharvest plant matter comprising a hydrocolloid polymer; an edible wax; a fatty acid; water; and an edible alkaline component essentially free of morpholine and/or ammonia. In some embodiments, said composition is referred to as a wet composition. According to another aspect there is provided a post-harvest plant matter coated with an edible coating comprising a hydrocolloid polymer; an edible wax; a fatty acid; and an edible alkaline component essentially free of morpholine and/or ammonia. According to some embodiments, the edible coating further comprises water. According to particular embodiments, the water is present in the coating in a weight percent of up to about 30%. In some embodiments, the edible coating is referred to as a dry composition.

The term “wet composition”, as used herein refers to a coating composition prior to or following application to the postharvest matter, but prior to drying of the coating composition. The term “dry composition”, as used herein refers to a coating composition following application to the postharvest matter and drying.

It has now been found that complete elimination of morpholine and replacing it with edible alkaline components in the coating composition allowed eliminating any safety concerns regarding the use of amine-comprising emulsifiers while increasing the coating compositions ability to reduce weight losses and quality during storage. Therefore, the coating composition of the present invention overcomes the disadvantages of known compositions by using a hydrocolloid-high wax coating which reduces weight and quality losses and does not add a potentially hazardous carcinogen to an otherwise edible plant matter.

Amine-comprising alkaline compounds, such as morpholine, are not approved for human consumption in the European Union due to safety reasons. Thus, in certain embodiments, the edible alkaline component is essentially free of morpholine and/or ammonia, and in certain embodiments, the edible alkaline component is essentially free of amines

The term “amines”, as used herein, refers to compounds containing a basic nitrogen atom having a lone pair of electrons Amines can be organic or inorganic compounds, and include primary, secondary, tertiary, and cyclic amines According to certain embodiments, amines include morpholine and/or ammonia.

The term “essentially free of morpholine” refers, in some embodiments, to an edible alkaline component comprising less than 0.05% (w/w) morpholine of the total weight of the wet composition, less than 0.04% (w/w), less than 0.02% (w/w) or less than 0.01% (w/w) morpholine of the total weight of the wet composition. Each possibility represents a separate embodiment of the invention. In additional embodiments, the term “essentially free of morpholine” refers to an edible alkaline component comprising less than 1% (w/w) morpholine of the total weight of the dry composition, less than 0.5% (w/w), less than 0.1% (w/w), less than 0.05% (w/w), or less than 0.01% (w/w) morpholine of the total weight of the dry composition. Each possibility represents a separate embodiment of the invention. In some embodiments, the edible alkaline component is free of morpholine. In another embodiment, the term refers to an edible alkaline component not containing detectable amounts of morpholine.

The term “essentially free of ammonia” refers, in some embodiments, to an edible alkaline component comprising less than 0.05% (w/w) ammonia of the total weight of the wet composition, less than 0.04% (w/w), less than 0.02% (w/w) or less than 0.01% (w/w) ammonia of the total weight of the wet composition. Each possibility represents a separate embodiment of the invention. In additional embodiments, the term “essentially free of ammonia” refers to an edible alkaline component comprising less than 1% (w/w) ammonia of the total weight of the dry composition, less than 0.5% (w/w), less than 0.1% (w/w), less than 0.05% (w/w), or less than 0.01% (w/w) ammonia of the total weight of the dry composition. Each possibility represents a separate embodiment of the invention. In some embodiments, the edible alkaline component is free of ammonia. In another embodiment, the term refers to an edible alkaline component not containing detectable amounts of ammonia.

The term “essentially free of amines” refers, in some embodiments, to an edible alkaline component comprising less than 0.05% (w/w) amines of the total weight of the wet composition, less than 0.04% (w/w), less than 0.02% (w/w), or less than 0.01% (w/w) amines of the total weight of the wet composition. Each possibility represents a separate embodiment of the invention. In additional embodiments, the term “essentially free of amines” refers to an edible alkaline component comprising less than 1% (w/w) amines of the total weight of the dry composition, less than 0.5% (w/w), less than 0.1% (w/w), less than 0.05% (w/w), or less than 0.01% (w/w) amines of the total weight of the dry composition. Each possibility represents a separate embodiment of the invention. In some embodiments, the edible alkaline component is free of amines. In another embodiment, the term refers to an edible alkaline component not containing detectable amounts of amines.

In some embodiments, the composition is essentially free of morpholine. In these embodiments, the term “composition essentially free of morpholine” refers to the coating composition comprising less than 0.05% (w/w) morpholine of the total weight of the wet composition, less than 0.04% (w/w), less than 0.02% (w/w), or less than 0.01% (w/w) morpholine of the total weight of the wet composition. Each possibility represents a separate embodiment of the invention. In additional embodiments, the term “composition essentially free of morpholine” refers to the coating composition comprising less than 1% (w/w) morpholine of the total weight of the dry composition, less than 0.5% (w/w), less than 0.1% (w/w), less than 0.05% (w/w), or less than 0.01% (w/w) morpholine of the total weight of the dry composition. Each possibility represents a separate embodiment of the invention. In further embodiments, the coating composition comprises less than about 5 ppm morpholine. In yet further embodiments, the coating composition comprises less than about 2 ppm morpholine. In still further embodiments, the coating composition comprises less than about 1 ppm morpholine. In some embodiments, the coating composition is free of morpholine. In another embodiment, the term refers to the coating compositions not containing detectable amounts of morpholine.

In further embodiments, the composition is essentially free of ammonia. In these embodiments, the term “composition essentially free of ammonia” refers to the coating composition comprising less than 0.05% (w/w) ammonia of the total weight of the wet composition, less than 0.04% (w/w), less than 0.02% (w/w), or less than 0.01% (w/w) ammonia of the total weight of the wet composition. Each possibility represents a separate embodiment of the invention. In additional embodiments, the term “composition essentially free of ammonia” refers to the coating composition comprising less than 1% (w/w) ammonia of the total weight of the dry composition, less than 0.5% (w/w), less than 0.1% (w/w), less than 0.05% (w/w) ammonia of the total weight of the dry composition, or less than 0.01% (w/w) ammonia of the total weight of the dry composition. Each possibility represents a separate embodiment of the invention. In some embodiments, the coating composition is free of ammonia. In another embodiment, the term refers to the coating compositions not containing detectable amounts of ammonia.

In other embodiments, the composition is essentially free of amines. In these embodiments, the term “composition essentially free of amines” refers to the coating composition comprising less than 0.05% (w/w) amines of the total weight of the wet composition, less than 0.04% (w/w), less than 0.02% (w/w), or less than 0.01% (w/w) amines of the total weight of the wet composition. Each possibility represents a separate embodiment of the invention. In additional embodiments, the term “composition essentially free of amines” refers to the coating composition comprising less than 1% (w/w) amines of the total weight of the dry composition, less than 0.5% (w/w), less than 0.1% (w/w), less than 0.05% (w/w), or less than 0.01% (w/w) amines of the total weight of the dry composition. Each possibility represents a separate embodiment of the invention. In some embodiments, the coating composition is free of amines. In another embodiment, the term refers to the coating compositions not containing detectable amounts of amines.

According to the preferred embodiments, the edible alkaline component allows formation of a homogeneous emulsion without the need for any additional emulsifier. The term “emulsion,” as used herein refers to a stable mixture of two or more immiscible components held in suspension. The mixture may be stabilized by the presence of emulsifiers or surfactants. According to some embodiments, the compositions of the present invention are essentially free of any additional emulsifier other that the edible alkaline component.

The term “composition essentially free of any additional emulsifier”, as used herein, refers, in some embodiments, to the coating composition comprising less than 0.05% (w/w) of the additional emulsifier of the total weight of the wet composition, less than 0.04% (w/w), less than 0.02% (w/w), or less than 0.01% (w/w) of the additional emulsifier of the total weight of the wet composition. Each possibility represents a separate embodiment of the invention. In additional embodiments, the term “composition essentially free of any additional emulsifier” refers to the coating composition comprising less than 1% (w/w) of the additional emulsifier of the total weight of the dry composition, less than 0.5% (w/w), less than 0.1% (w/w), less than 0.05% (w/w), or less than 0.01% (w/w) of the additional emulsifier of the total weight of the dry composition. Each possibility represents a separate embodiment of the invention. In some embodiments, the coating composition is free of the additional emulsifier.

According to some embodiments, the coating compositions of the present invention are stable at ambient conditions for at least one month. According to further embodiments, the coating compositions are stable for at least two, three, four, five or even six months. Each possibility represents a separate embodiment of the invention. According to some embodiments, the coating compositions are stable at ambient conditions for more than six months.

According to some embodiments, the coating compositions are stable at cold storage conditions, such as, for example at a temperature of about 0-5° C. for at least one month. According to further embodiments, the coating compositions are stable for at least two, three, four, five or even six months. Each possibility represents a separate embodiment of the invention. According to some embodiments, the coating compositions are stable at cold storage conditions for more than six months.

The term “edible alkaline component” as used herein refers to any alkaline material having a pKa and/or pH greater than about 7 and is safe for ingestion by humans.

In the currently preferred embodiments, the edible alkaline component is an inorganic alkaline component. In certain embodiments, the edible alkaline component is an alkaline salt. In certain embodiments, the edible inorganic alkaline component is an alkali metal salt or an alkaline earth metal salt. According to some embodiments, the alkali metal salt includes cations selected from sodium or potassium. According to some embodiments the alkaline earth metal salt includes cations selected from magnesium, calcium or barium. According to some embodiments, the edible inorganic alkaline component includes anions selected from hydroxide, carbonate, or bicarbonate. The non-limiting examples of edible inorganic alkaline components include sodium hydroxide, potassium hydroxide, magnesium hydroxide, calcium hydroxide, barium hydroxide, sodium carbonate, potassium carbonate, magnesium carbonate, calcium carbonate, barium carbonate, sodium bicarbonate, potassium bicarbonate, magnesium bicarbonate, calcium bicarbonate, barium bicarbonate or combinations thereof. According to the currently preferred embodiments, the edible inorganic alkaline component is selected from the group consisting of sodium hydroxide, potassium hydroxide, sodium carbonate, potassium carbonate, sodium bicarbonate, potassium bicarbonate, and combinations thereof.

In certain embodiments, the edible alkaline component is present in a weight percent ranging from about 0.05% to about 2% of the total weight of the wet composition. In certain embodiments, the edible alkaline component is present in a weight percent of 1%. In certain embodiments, the edible alkaline component is present in a weight percent of 2%. In certain embodiments, the edible alkaline component is present in a weight percent of 0.05% or more. In certain embodiments, the edible alkaline component is present in a weight percent of 1% or more. In certain embodiments, the edible alkaline component is present in a weight percent of 2% or less. Each possibility represents a separate embodiment of the present invention.

It should be understood that while the coating composition is applied to the plant matter in the form of a solution, the solution adhered to the plant matter is later dried, i.e. loses at least part of its water content. Therefore, in some embodiments, the edible alkaline component is present in a weight percent ranging from about 1% to about 30% of the total weight of the dry composition. In certain embodiments, the edible alkaline component is present in a weight percent of 1% or more of the dry composition. In certain embodiments, the edible alkaline component is present in a weight percent of 30% or less of the dry composition. In some embodiments, the edible alkaline component is present in a weight percent ranging from about 1% to about 30% of the total weight of the edible coating.

The term “hydrocolloid” as used herein refers to a water soluble polymer, of biotic, e.g., vegetable, animal, microbial, fossil, or abiotic, i.e., synthetic origin, that generally contains many hydroxyl groups and is capable of increasing the viscosity of the coating layer.

In certain embodiments, the hydrocolloid is a gelling hydrocolloid. In certain such embodiments, the hydrocolloid is selected from the group consisting of alginate, agar, agarose, gelatin, low methoxy pectin (LMP), chitosan, gellan, carrageenan, cellulose, carboxymethyl cellulose, arabinoxylan, curdlan, β-glucan, pectin, starch, gum arabic, gum tragacanth, tamarind gum, fenugreek gum, cassia gum, tara gum and mixtures thereof. Each possibility represents a separate embodiment of the present invention. In a specific embodiment, the hydrocolloid is alginate. In other embodiments, the hydrocolloid is a non-gelling hydrocolloid. In certain such embodiments, the hydrocolloid is selected from the group consisting of locust bean gum (LBG), guar gum, xanthan gum, lambda-carrageenan and mixtures thereof. Each possibility represents a separate embodiment of the present invention. In a specific embodiment, the hydrocolloid is guar gum. In another specific embodiment, the hydrocolloid is locust bean gum.

In certain embodiments, the hydrocolloid is present in a weight percent ranging from about 0.5% to about 5% of the total weight of the wet composition. In certain embodiments, the hydrocolloid is present in a weight percent of 0.5% or more. In certain embodiments, the hydrocolloid is present in a weight percent of 5% or less.

In certain embodiments, the hydrocolloid is present in a weight percent ranging from about 20% to about 60% of the total weight of the dry composition. In certain embodiments, the hydrocolloid is present in a weight percent of 20% or more of the total weight of the dry composition. In certain embodiments, the hydrocolloid is present in a weight percent of 60% or less of the total weight of the dry composition. Each possibility represents a separate embodiment of the present invention. In certain embodiments, the hydrocolloid is present in a weight percent ranging from about 20% to about 60% of the total weight of the edible coating.

According to some particular embodiments, the coating composition comprises a gelling hydrocolloid and an alkali metal salt. According to other particular embodiments, the coating composition comprises a non-gelling hydrocolloid and an alkali metal salt or an alkaline earth metal salt.

The term “edible wax” as used herein refers to both synthetic waxes that are suitable for human consumption, such as food-grade petroleum products, and to natural waxes obtained from plants, insects (honeybees or others) or animals. Non-limiting Examples of vegetable waxes include candelilla wax, Japan wax, soy wax, castor wax, bayberry wax and mixtures thereof. Each possibility represents a separate embodiment of the present invention. Preferably, the edible wax is selected from animal or insect waxes such as beeswax. The edible wax may further be selected from mineral waxes, such as, but not limited to montan wax or from petroleum waxes, such as but not limited to, microcrystalline wax and paraffin wax. Preferably, the edible wax is selected from waxes having a melting temperature lower than 70° C., such as, but not limited to, beeswax having a melting temperature of between 62-64° C.

In certain embodiments, the edible wax is selected from the group consisting of beeswax, carnauba wax, candelilla wax, alpha wax, montan wax, rice-bran wax, Japan wax and mixtures thereof. In a specific embodiment, the edible wax is beeswax. In certain embodiments, the edible wax has a melting temperature of about 70° C. or lower. In certain embodiments, the edible wax is present in a weight percent ranging from about 0.1% to about 5% of the total weight of the wet composition. In certain embodiments, the edible wax is present in a weight percent of 0.1% or more. In certain embodiments, the edible wax is present in a weight percent of 5% or less. In certain embodiments, the edible wax is present in a weight percent of 0.2%, 0.5%, 1%, 1.3%, 2% or 5%. Each possibility represents a separate embodiment of the present invention.

In certain embodiments, the edible wax is present in a weight percent ranging from about 2% to about 35% of the total weight of the dry composition. In certain embodiments, the edible wax is present in a weight percent of 2% or more of the total weight of the dry composition. In certain embodiments, the edible wax is present in a weight percent of 35% or less of the total weight of the dry composition. Each possibility represents a separate embodiment of the present invention. In certain embodiments, the edible wax is present in a weight percent ranging from about 2% to about 35% of the total weight of the edible coating.

In certain embodiments, the fatty acid is selected from the group consisting of oleic acid, stearic acid, palmitic acid, lauric acid, myristic acid, behenic acid, isostearic acid, and mixtures thereof. In a specific embodiment, the fatty acid is oleic acid. In an embodiment, the fatty acid is a mixture of oleic acid and stearic acid. In a specific embodiment, the fatty acid is 50% by weight oleic acid and 50% by weight stearic acid. Each possibility represents a separate embodiment of the present invention.

In some embodiments, the composition further comprises a natural compound isolated from the surface of said plant matter or a compound substantially equal thereto. In some embodiments, addition of said natural compound to the composition induces coating adhesion to the coated plant matter. In other embodiments, the addition of said natural compound allows to retain the natural color of the coated commodity. In certain embodiments, said compound is a sterol. In certain embodiments, said sterol is selected from the group consisting of β-sitosterol, ergosterol, sigmaterol and mixtures thereof. In a specific embodiment, said compound is β-sitosterol. In certain embodiments, said compound is quercetin. In such certain embodiments, the addition of quercetin allows to retain the natural color of the coated bulb onions upon application of the coating composition. Each possibility represents a separate embodiment of the present invention.

In some embodiments, the composition further comprises a cross-linking and/or a gelation-inducing agent such as, for example, barium ions, potassium ions, calcium ions, magnesium ions, ferrous ions or aluminum ions, capable of causing the jellification of the composition. Each possibility represents a separate embodiment of the present invention.

In certain embodiments, the coating compositions described above is for use in combination with a composition comprising a cross-linking and/or a gelation inducing agent such as, for example, barium ions, potassium ions, calcium ions, magnesium ions, ferrous ions or aluminum ions, capable of causing the jellification of the coating composition. Each possibility represents a separate embodiment of the present invention. In certain such embodiments, the coating composition comprises a gelling hydrocolloid. According to some embodiments, the coating composition and the composition comprising a cross-linking and/or a gelation-inducing agent are kept in separate containers prior to application of the coating composition to the plant matter. Thus, in some embodiments, there is provided a kit, comprising, as separate components, the coating composition according to the principles of the present invention and the composition comprising a cross-linking and/or a gelation-inducing agent.

Polyamines play important roles in many physiological processes in plants. Treatment with exogenous polyamines has been reported to increase fruit firmness in apples, strawberry, tomato, lemon, peach and plum. Other beneficial effects of exogenous polyamines have been reported for both climacteric and non-climacteric fruit such as delayed color changes, reduced mechanical damage and susceptibility to chilling injury and increased shelf life. Thus, polyamines incorporation in the coating formulations has the potential for control of quality properties and increased shelf life of harvested fruit (Not Sci Biol, 2013. 5(2):212-219).

In some embodiments, the composition further comprises an agent capable of slowing down ripening of the plant organs, such as, but not limited to, aminoethoxyvinyiglycine (AVG) or 1-methylcyclopropene (1-MCP). In other embodiments, the coating composition compounds further comprises an ethylene retarding agent as known in the art, such as, but not limited to, silver nitrate, silver applied in the form of thiosulfate, and other silver salts, as well as Gibberellins, 2,5-norbomadiene or trans-cy-dooctene. Each possibility represents a separate embodiment of the present invention.

In some embodiments, the composition further comprises an ethylene releasing agent for regulating (with or without temperature manipulation) the ripening processes of fruit, The non-limiting examples of ethylene releasing agents include calcium carbide, ethanol, methanol, ethylene glycol, ethephon, ethanedial dioxime, etacelasil, 2-chloroethyl-methylbis(phenylmethoxy)-silane, and 1-aminocyclopropane-1-carboxylic acid.

In some embodiments, the composition further comprises an agent capable of slowing down growth and elongation of the plant organs and allow for enhanced ripening, such as, but not limited to anti-gibberellins. Anti-gibberellin compounds may include, but are not limited to, onium compounds; compounds with an N-containing heterocycle; structural mimics of 2-oxoglutaric acid or acyl cyclohexanediones; or 16,17-Dihydro-GA5 and derivatives thereof. The non-limiting examples of onium compounds include chlormequat chloride, mepiquat chloride, chlorphonium, and AMO-1618, which block the cyclases copalyl-diphosphate synthase and ent-kaurene synthase involved in the early steps of GA metabolism. The non-limiting examples of the compounds with an N-containing heterocycle include ancymidol, flurprimidol, tetcyclacis, paclobutrazol, uniconazole-P, and inabenfide. These retardants block cytochrome P450-dependent monooxygenases, thereby inhibiting oxidation of ent-kaurene into ent-kaurenoic acid. Structural mimics of 2-oxoglutaric acid are the co-substrates of dioxygenases that catalyze late steps of GA formation. Acyl cyclohexanediones, e.g. prohexadione-Ca and trinexapac-ethyl and daminozide, block particularly 3ß-hydroxylation, thereby inhibiting the formation of highly active GAs from inactive precursors. 16,17-Dihydro-GA5 and related structures act most likely by mimicking the GA precursor substrate of the same dioxygenases. The agent capable of slowing down growth and elongation of the plant organs can thus be selected from 2-chloroethyl trimethyl ammonium chloride (CCC); 2,4-dichlorobenzyl-tributylphosphonium chloride (Phosphon-D); alyl trimethylammonium bromide (AMAB); 2-isopropyl-4-dimethylamino-5methylphenyl-1-piperidine-carboxylate methyl chloride (AMO-1618); (2S,3S)-1-(4-chlorophenyl)-4,4-dimethyl-2-(1,2,4-triazol-1-yl)pentan-3-ol (Paclobutrazol), and the like.

In some embodiments, the edible coating composition further comprises scavengers. The term “scavenger”, as used herein, refers to a chemical substance added to a mixture in order to remove or de-activate impurities and unwanted reaction products, for example oxygen and oxygen free radicals (OFR). According to some embodiments, said scavengers are oxygen and OFR scavengers.

The coating composition of the present invention can optionally contain additional substances selected from the group consisting of anti-foaming agents, such as polydimethylsiloxane; preservative agents, such as sorbic acid and its salts, benzoic acid and its salts, calcium propionate, sodium nitrite, sulfites, such as sulfur dioxide, sodium bisulfate or potassium hydrogen sulfite, adhesive agents, such as gelatin and gum karaya, and polycations such as chitosan, plasticizers, such as glycerol, acetylated monoglycerides, polyethylene glycol and surface-tension reducing agents. Each possibility represents a separate embodiment of the present invention. Exemplary additional substances include polydimethylsiloxane (PDMS), sodium bisulfite, sodium benzoate, sodium propionate, calcium propionate, benzoic acid, potassium sorbate, polyethylene glycol, glycerol, propylene glycol, sorbitol, mannitol, and HUMKOTE®. Each possibility represents a separate embodiment of the present invention.

According to the principles of the present invention, the inclusion of additional substances in the coating composition is performed in order to obtain a wax-hydrocolloid coating composition having desired properties such as, but not limited to desired viscosity, plasticity and elasticity, hydrophobicity, permeability, smoothness, glossiness, strength and resistance to shearing forces, pH, and the like. For Example, the additives may provide other characteristics, functions, or properties to the coating composition of the present invention, such as, but not limited to, disinfectant properties.

As explained hereinabove, the compositions of the present invention extend the shelf life of a plant matter coated with the composition by maintaining quality and reducing weight losses thereof. According to some embodiments, the coating compositions of the invention provide the extension of shelf life of edible plant matter by modifying the internal atmosphere, by reducing the extent of weight loss and endogenic metabolic and developmental processes, and quality deterioration and spoilage during storage. According to some embodiments, the coating compositions of the present invention provide the extension of the shelf life of the edible plant matter for between several days to several weeks beyond the shelf life of uncoated edible plant matter of the same variety from the same field under the same storage conditions. According to some embodiments, the shelf life of an edible plant matter coated with the coating composition of the invention is at least 20% higher than the shelf life of an uncoated plant matter under the same storage conditions; alternatively, at least 25% higher, alternatively at least 30% higher; alternatively at least 35% higher, alternatively at least 40% higher. According to some embodiments, the shelf life of an edible plant matter coated with the coating composition of the invention is doubled as compared to the shelf life of an uncoated plant matter under the same storage conditions. According to some embodiments, the coating compositions of the present invention provide the extension of the shelf life of the non-edible plant matter, including medicinal or ornamental plants for between several days to several weeks beyond the shelf life of uncoated plant matter of the same variety from the same field under the same storage conditions.

In certain embodiments, the plant matter is an edible plant matter. In certain such embodiments, the edible plant matter comprises a fruit or a vegetable, including, but not limited to: storage roots, such as, for example, sweet potato; leaves such as, for example, lettuce; stems, such as, for example, potatoes or kohlrabi; flower initials and buds, such as, for example, cauliflower or broccoli; inflorescence buds such as, for example, artichoke, immature fruits, such as, for example, eggplants, cucumbers; mature fruit, such as, for example, tomatoes; and seeds (for food and for propgation), such as, for example, beans or peas. According to some embodiments the plant matter has natural epidermal layers, also termed herein shell/skin/tunic. The term “fruit or vegetable having a natural shell/skin/tunic” refers to any fruit or vegetable which during its normal growth, maturation and/or ripening develops an external protecting tissue. The external plant tissues are generally coated with some natural coating, for example, leaves are coated with cuticle; tree trunks with bark; fruit with either soft skin as in peaches, dates, apricots, plums, or with thick peel as in oranges, water melons, bananas; dry tunic as in onions and garlic, or hard dry shell as in nuts and certain legumes including peanuts. In some embodiments, the compositions of the present invention are particularly useful for coating plant matter comprising scale leaves. The non-limiting examples of fruit and vegetable having leaf scales include bulbs, either edible or ornamental, including, inter alia, onions, shallots, garlic and bulbs of ornamental plants.

In certain embodiments, the edible plant matter is selected from, but not limited to, garlic, onions, shallots, tomatoes, peppers, eggplants, potatoes, carrot, sweet potatoes, broccolis, cauliflowers, cabbages, zucchinis, parsley, celery, leek, turnip, parsnip, artichoke, salsify, lettuce, apples, strawberries, grapes, blueberries, mango, papaya, kiwis, cantaloupes, melons, watermelons, pineapples and any other fruits or vegetables. In a specific embodiment, the edible plant matter is garlic. In a specific embodiment, the edible plant matter is onions. In a specific embodiment, the edible plant matter is peppers. In some embodiments, the peppers are selected from the group consisting of bell peppers, sweet peppers, chili peppers, and paprika peppers. The peppers can include all stages of fruit development irrespective of size and shape, such as green (immature) and red (mature) and all other in between (e.g., turning point/breaker; pink and more) ripening stages. The peppers can further include peppers of different colors irrespective of size and shape (red, yellow, orange, green, khaki, chocolate/brown, vanilla/white, and purple), shapes and sizes, pungency, sweetness, capsanthin or capsaicin contents, or dry matter contents. In a specific embodiment, the edible plant matter is an eggplant. The eggplant can be of different sizes and colors (e.g., different varieties of eggplant may range from indigo to white including dark violet and forest green). In a specific embodiment, the edible plant matter is shallot, including the gray shallot (Griselle). In a specific embodiment, the edible plant matter is potatoes. In other embodiments, the plant mater is a bulbous geophyte, including but not limited to, tulips, irises, lilies, or daffodils. Additional geophyte species important as medicinal and aromatic plants include anemone, crocus, colchicum, cyclamen, eranthis, fritillaria, galanthus, iris, leucojum, muscari, narcissus, ornithogalu, orchis, arum and scilla.

In certain embodiments, the composition is configured to provide an artificial coating to the postharvest plant matter. In some embodiments, the postharvest plant matter has scales (e.g., bulb onion; shallot). The term “artificial coating” as used herein refers to the plant matters' coating layer, applied by applying the coating composition to the plant matter.

In the preferred embodiments, the coating composition is edible.

In some embodiments, the coating composition comprises about 1%-5% (w/w) of hydrocolloid; about 0.1%-5% (w/w) of edible wax; about 0.01%-2% (w/w) of fatty acid; about 0.05%-2% (w/w) of edible alkaline component; and about 83%-99% water, of the total weight of the wet coating composition.

In some embodiments, the coating composition comprises about 0.25%-1.25% (w/w) of hydrocolloid; about 0.05%-50% (w/w) of edible wax; about 0.01%-2% (w/w) of fatty acid; about 0.05%-2% (w/w) of edible alkaline component; and about 50%-99% water, of the total weight of the wet coating composition.

In some embodiments, the coating composition comprises about 20%-60% (w/w) of hydrocolloid; about 2%-35% (w/w) of edible wax; about 1%-40% (w/w) of fatty acid; about 1%-30% (w/w) of edible alkaline component; and about 4%-30% water, of the total weight of the dry coating composition. In some embodiments, the edible coating comprises about 20%-60% (w/w) of hydrocolloid; about 2%-35% (w/w) of edible wax; about 1%-40% (w/w) of fatty acid; about 1%-30% (w/w) of edible alkaline component; and about 4%-30% water, of the total weight of the edible coating.

In some embodiments, the coating composition comprises about 1%-5% (w/w) of hydrocolloid; about 0.1%-5% (w/w) of edible wax; about 0.01%-2% (w/w) of fatty acid; about 0.05%-2% (w/w) of edible alkaline component; up to about 0.2% (w/w) of sterol; and about 83%-99% water, of the total weight of the wet coating composition.

In certain such embodiments, the hydrocolloid is alginate. In certain such embodiments, the edible wax is beeswax. In certain such embodiments, the fatty acid is oleic acid. In certain such embodiments, the edible alkaline component is potassium hydroxide. In certain such embodiments, the edible alkaline component is sodium hydroxide. In certain such embodiments, the edible alkaline component is sodium carbonate. In certain such embodiments, the sterol is sitosterol. Each possibility represents a separate embodiment of the present invention.

In certain such embodiments, the hydrocolloid is locust bean gum. In certain such embodiments, the hydrocolloid is guar gum. In certain such embodiments, the edible wax is beeswax. In certain such embodiments, the fatty acid is oleic acid. In certain such embodiments, the edible alkaline component is potassium hydroxide.Each possibility represents a separate embodiment of the present invention.

In certain embodiments, the coating composition comprising about 1%-5% (w/w) of hydrocolloid; about 0.1%-5% (w/w) of edible wax; about 0.01%-2% (w/w) of fatty acid; about 0.05%-2% (w/w) of edible alkaline component; and about 83%-99% water, of the total weight of the wet coating composition, is applied to onions. In other embodiments, the coating composition comprising about 1%-5% (w/w) of hydrocolloid; about 0.1%-5% (w/w) of edible wax; about 0.01%-2% (w/w) of fatty acid; about 0.05%-2% (w/w) of edible alkaline component; and about 83%-99% water, of the total weight of the wet coating composition, is applied to garlic.

In certain embodiments, the coating composition comprising about 0.25%-1.25% (w/w) of hydrocolloid; about 0.05%-50% (w/w) of edible wax; about 0.01%-2% (w/w) of fatty acid; about 0.05%-2% (w/w) of edible alkaline component; and about 50%-99% water, of the total weight of the wet coating composition, is applied to peppers. In other embodiments, the coating composition comprising about 0.25%-1.25% (w/w) of hydrocolloid; about 0.5%-50% (w/w) of edible wax; about 0.01%-2% (w/w) of fatty acid; about 0.05%-2% (w/w) of edible alkaline component; and about 50%-99% water, of the total weight of the wet coating composition, is applied to eggplants.

In some embodiments, the coating composition comprises about 1%-5% (w/w) of alginate; about 0.1%-5% (w/w) of beeswax; about 0.01%-2% (w/w) of oleic acid; about 0.05%-2% (w/w) of sodium hydroxide; and about 83%-99% water, of the total weight of the wet coating composition. In additional embodiments, the coating composition comprises about 1%-5% (w/w) of alginate; about 0.1%-5% (w/w) of beeswax; about 0.01%-2% (w/w) of oleic acid; about 0.05%-2% (w/w) of sodium hydroxide; and about 83%-99% water, of the total weight of the wet coating composition. In a specific embodiment, the coating composition comprises about 2% (w/w) of alginate; about 0.2% (w/w) of beeswax; about 1.8% (w/w) of oleic acid; about 0.12% (w/w) of sodium hydroxide; about 0.2% sitosterol and about 96% water, of the total weight of the wet coating composition.

In a specific embodiment, the coating composition comprises about 0.5% (w/w) of locust bean gum; about 15% (w/w) of beeswax; about 1.8% (w/w) of oleic acid; about 0.5% (w/w) of sodium hydroxide; and about 82% water, of the total weight of the wet coating composition. In a specific embodiment, the coating composition comprises about 0.5% (w/w) of locust bean gum; about 15% (w/w) of beeswax; about 1.8% (w/w) of oleic acid; about 0.54% (w/w) of sodium hydroxide; and about 82% water, of the total weight of the wet coating composition. In a specific embodiment, the coating composition comprises about 0.5% (w/w) of guar gum; about 15% (w/w) of beeswax; about 1.8% (w/w) of oleic acid; about 0.54% (w/w) of sodium hydroxide; and about 82% water, of the total weight of the wet coating composition.

In another aspect, the present invention provides a method for reducing the weight loss and quality and extending shelf life of a post-harvest plant matter by providing an artificial coating, comprising the step of applying to the surface of the plant matter a coating composition comprising an edible hydrocolloid polymer; an edible wax; an edible fatty acid; water; and an edible alkaline component essentially free of morpholine and/or ammonia, thereby coating the edible plant matter with the coating composition. In some embodiments, the method comprises the step of applying to the surface of the plant matter a coating composition comprising an edible hydrocolloid polymer; an edible wax; an edible fatty acid; water; and an edible alkaline component, wherein the edible alkaline component is essentially free of amines. In further embodiments, the method comprises the step of applying to the surface of the plant matter a coating composition comprising an edible hydrocolloid polymer; an edible wax; an edible fatty acid; water; and an edible alkaline component; wherein the edible alkaline component is an inorganic alkaline component.

According to some embodiments, the coating composition is applied to the surface of the plant matter by rubbing, spraying or brushing the coating composition onto the surface of the plant, possibly by using of rubber, brush or synthetic polymer gloves, brushing onto the plant organs' surface with coating composition; dipping or immersing the edible plant matter in the coating composition, spraying the coating composition onto the edible plant matter, pouring the coating composition onto the plant matter, possibly when the plant matter is handled after harvest, e.g., when manually handled or while moving on a conveyor belt. Each possibility represents a separate embodiment of the present invention. In certain embodiments, the composition is applied by falling film evaporation.

The coating composition may be applied at a certain temperature to provide a substantially uniform coating of the fruit or vegetable. According to some embodiments, the application of the coating composition of the present invention to the surface of the plant matter is performed at room temperature (25° C.±10° C.). According to some embodiments, the coating composition is applied to the surface of the plant matter when the temperature of the coating composition is between 35° C. to 70° C. It will be recognized by one of skill in the art that the coating composition of the present invention is more easily applied in a liquid form. Accordingly, the coating composition may be applied at a temperature in which the edible wax is liquefied or partly liquefied, but at a temperature low enough so that the plants tissues do not suffer injuries.

According to some embodiments, the coating composition is applied to the plant matter in a volume of from about 0.5 μl to about 500 μl of the wet composition per about 100 g of the plant matter. According to certain embodiments, the volume of the applied composition is from about 5 μl to about 25 μl. In certain such embodiments, the plant matter is pepper. In some exemplary embodiments, the volume of the applied composition is about 10 μl.

In certain embodiments, the method further comprises the steps of allowing the excess coating composition to drip from the plant matter.

According to further embodiments, the method includes the steps of applying to the plant matter additional composition comprising cross-linking or gelation inducing agents. In certain such embodiments, the hydrocolloid polymer comprises a gelling hydrocolloid. According to some embodiments, the composition comprising cross-linking or gelation inducing agents is applied to the plant matter following the application of the coating composition. According to some embodiments, the composition comprising cross-linking or gelation inducing agents is applied to the plant matter prior to the application of the coating composition. In some embodiments, the coating composition comprising a hydrocolloid polymer; an edible wax; an edible fatty acid; an edible alkaline component essentially free of morpholine and/or ammonia; and water, and the composition comprising cross-linking or gelation inducing agents are applied simultaneously or sequentially. In some embodiments, the coating composition applied to a plant matter comprises a hydrocolloid polymer; an edible wax; an edible fatty acid; an edible alkaline component essentially free of morpholine and/or ammonia; water and a cross-linking agents or gelation inducing agent.

In some embodiments, the cross-linking or gelation inducing agents include barium chloride, calcium chloride magnesium chloride, iron (II) chloride, aluminum chloride or a combination thereof. In some embodiments, the cross-linking or gelation inducing agent is edible. According to some embodiments, the composition comprising the cross-linking or gelation inducing agent is applied to the surface of the plant matter by rubbing, spraying or brushing the composition onto the surface of the plant, possibly by using a rubber, brush or synthetic polymer gloves, dipping or immersing the edible plant matter in the composition, spraying the composition onto the edible plant matter, pouring the composition onto the plant matter, possibly when the plant matter is manually or mechanically handled, e.g., moving on a conveyor belt. Each possibility represents a separate embodiment of the present invention. In certain embodiments, the composition comprising the cross-linking or gelation inducing agent is applied by falling film evaporation.

In some embodiments, the method further comprises a drying step. Drying of the coated plant matter is typically performed by allowing the coated plant tissue to dry at room temperature. Alternatively, the coating composition may be left to dry or actively dried after its application to the surface of the plant tissues by any method or under any conditions known in the art at the decision of the one skilled in the art.

According to some embodiments, the thickness of the applied and dried coating is from about 0.1 μm to about 10 μm. According to the currently preferred embodiments, the thickness of the coating is from about 0.5 μm to about 5 μm, such as, for example about 1 μm.

In further embodiments, the method comprises a step of brushing of the coated plant tissues. In such embodiments, the brushing allows to maintain or increase the original gloss of the plant tissue.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed methods

As used herein and in the appended claims the singular forms “a”, “an” and “the” include plural references unless the content clearly dictates otherwise. It should be noted that the term “and” or the term “or” is generally employed in its sense including “and/or” unless the content clearly dictates otherwise.

The following Examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1

### Coating of Onions and Garlic

### Materials and Methods

The coating compositions used throughout the experiments of Examples 2-12 are summarized in Tables 1 and 2, below.

TABLE 1
Compositions.

| # | Alg* | BW* | OA* | SA* | PA* | β-sit* | Amm* | NaOH | KOH | Na₂CO₃ | Mor* |
|---|---|---|---|---|---|---|---|---|---|---|---|
| 1 | 2% | 0.2% | 1.8% | | | 0.2% | | | | | 0.25% |
| 2 | 2% | 0.2% | 1.8% | | | 0.2% | 0.3% | | | | |
| 3 | 2% | 0.2% | 0.9% | 0.9% | | 0.2% | 0.3% | | | | |
| 4 | 2% | 1% | 1.8% | | | 0.2% | 1.5% | | | | |
| 5 | 2% | 2% | 1.8% | | | 0.2% | 3% | | | | |
| 6 | 2% | 5% | 1.8% | | | 0.2% | 7.5% | | | | |
| 7 | 2% | 0.2% | 1.8% | | | | 0.3% | | | | |
| 8 | 2% | 1% | 1.8% | | | | 1.5% | | | | |
| 9 | 2% | 0.2% | 1.8% | | | 0.2% | | 0.12% | | | |
| 10 | 2% | 0.2% | 1.8% | | | 0.2% | | | 0.15% | | |
| 11 | 2% | 0.2% | 1.8% | | | 0.2% | | | | 1.6% | |
| 12 | 2% | 1% | 0.5% | | | | 0.3% | | | | |
| 13 | 2% | 1% | 1.8% | | | 0.2% | | | 0.15% | | |
| 14 | 2% | 1% | 0.5% | | | | | | 0.15% | | |
| 15 | 2% | 0.2% | 0.9% | 0.9% | | 0.2% | | | 0.15% | | |
| 16 | 2% | 0.2% | 0.9% | | 0.9% | 0.2% | | | 0.15% | | |
| 17 | 2% | 0.2% | 0.9% | 0.45% | 0.45% | 0.2% | | | 0.15% | | |
| 18 | 2% | 2% | 1.8% | | | 0.2% | | | 0.15% | | |
| 19 | 2% | 2% | 0.5% | | | | | | 0.15% | | |
| 20 | 2% | 1.5% | 1.8% | | | 0.2% | | | 0.15% | | |
| 21 | 2% | 1.5% | 0.5% | | | | | | 0.15% | | |
| 22 | 2% | 1% | 1.8% | | | 0.2% | 0.3% | | | | |
| 23 | 2% | 1.3% | 0.5% | | | 0.2% | | | 0.15% | | |
| 24 | 2% | 1% | 0.33% | | | | | | 0.15% | | |
| 25 | 1% | 0.5% | 0.0165% | | | | | | 0.0755% | | |

The percentages are by weight (% w/w).
*Alg—alginate;
BW—beeswax;
OA—oleic acid;
SA—stearic acid;
PA—palmitic acid;
β-sit—β-sitosterol;
Amm—ammonia;
Mor—morpholine.

TABLE 2
Compositions per Example

| | Example | | | | | | | | | | |
|---|---|---|---|---|---|---|---|---|---|---|---|
| Composition | 2 | 3 | 4 | 5 | 6 | 7 | 8 | 9 | 10 | 11 | 12 |
| 1 | + | | | + | | | | | | | |
| 2 | + | + | + | + | | | + | | | | |
| 3 | + | | | | | | | | | | |
| 4 | | + | | | | | | | | | |
| 5 | | + | | | | | | | | | |
| 6 | | + | | | | | | | | | |
| 7 | | + | | | | | | | | | |
| 8 | | + | | | | | | | | | |
| 9 | | | + | + | | | + | | | | |
| 10 | | | + | + | | + | + | | | | |
| 11 | | | + | + | | | + | | | | |
| 12 | | | | | + | | | | + | | |
| 13 | | | | | + | | | | + | | |
| 14 | | | | | + | | | | | | |
| 15 | | | | | | + | | | | | |
| 16 | | | | | | + | | | | | |
| 17 | | | | | | + | | | | | |
| 18 | | | | | | | | + | | | |
| 19 | | | | | | | | + | | | |
| 20 | | | | | | | | + | | | |
| 21 | | | | | | | | + | | + | + |
| 22 | | | | | | | | | + | | |
| 23 | | | | | | | | | | + | |
| 24 | | | | | | | | | | + | + |
| 25 | | | | | | | | | | | + |

### Formulation Preparation

Alginate was dissolved in distilled water, followed by blending/homogenization of fatty acids (e.g. oleic acid, stearic acid, palmitic acid or β-sitosterol). An alkaline component (e.g. KOH, NaOH, ammonia, morpholine or Na₂CO₃) was then added to the solution. The last step included addition of the melted wax. It is important to note that the temperature of the alginate solution was higher than the melting temperature of the wax.

### Formulation Application

Freshly harvested onion and garlic bulbs, were cured under ambient conditions for 2-3 weeks as deemed necessary, washed in water and dried gently using very soft paper towels (Hogla, Hadera, Israel). Hydrocolloid-high wax coatings were applied by immersing a bulb in a coating bath comprising a hydrocolloid-high wax coating composition. Residual coating composition was allowed to drip off, before immersing the bulb in a 2% (w/w) solution of calcium chloride for about 30 s to induce a spontaneous cross-linking reaction. Coated bulbs were then left to dry at ambient temperature.

### Weight Loss Measurement

### Onions

100 bulb onions (‘Orlando’ HaZera Genetics, Israel) per treatment were used to compare weight-loss rates as a function of the Formulation type. Since weight loss is effected by edible plant size and surface area [Díaz-Pérez et al., J. Sci. Food and Agri., 87, 68-73, 2007], the bulb onions were sorted out to about the same size with an average weight of 100 g. Individual bulbs were weighed (±0.01 g) daily for 7 days using a STANDARD Series 165 BJ1000C balance (Precisa Gravimetrics AG, Dietikon, Switzerland). The scale was attached to a computer and data were collected using BALINT V5.00 software (Balance interface for Windows, Precisa Instruments AG, Dietikon, Switzerland). Results are presented as average (W₀−Wₜ)×100/W₀, where W₀ is the weight at time zero (i.e. initial weight) and Wₜ is the onion's weight after elapsed time t. All onions were stored at 21° C. and 50% RH. The vapor pressure deficit (VPD), which is the difference between the amount of moisture in the air and the amount of moisture the air can hold when saturated, was 1.24 kPa. Pictures of the bulb onions were taken during storage using a digital camera (Nikon Coolpix 600, Tokyo, Japan).

### Garlic

Garlic bulbs (‘Shani’), raised from a virus free clonally propagated material that were raised under protection to prevent contamination and infection with pests, including viruses, were used to compare weight-loss rates as a function of the edible alkaline component type in Formulations. The garlic bulbs were sorted for size thus having an average weight of 60±10 g. Each garlic bulb was weighed (±0.01 g) daily for at least 7 days using a STANDARD Series 165 BJ1000C balance (Precisa Gravimetrics AG, Dietikon, Switzerland). The scale was attached to a computer and data were collected using BALINT V5.00 software (Balance interface for Windows, Precisa Instruments AG, Dietikon, Switzerland). Results are presented as average (W₀−Wₜ)×100/W₀, where W₀ is the weight at time zero (i.e. initial weight) and Wₜ is the garlic's weight after elapsed time t. All garlic bulbs were stored at 21° C. and 50% RH. The vapor pressure deficit (VPD), which is the difference between the amount of moisture in the air and the amount of moisture the air can hold when it is saturated, was 1.24 kPa. Pictures of the garlic bulbs were taken during storage using a digital camera (Nikon Coolpix 600, Tokyo, Japan).

### Example 2

### Weight Loss—Comparison of Morpholine with Ammonia

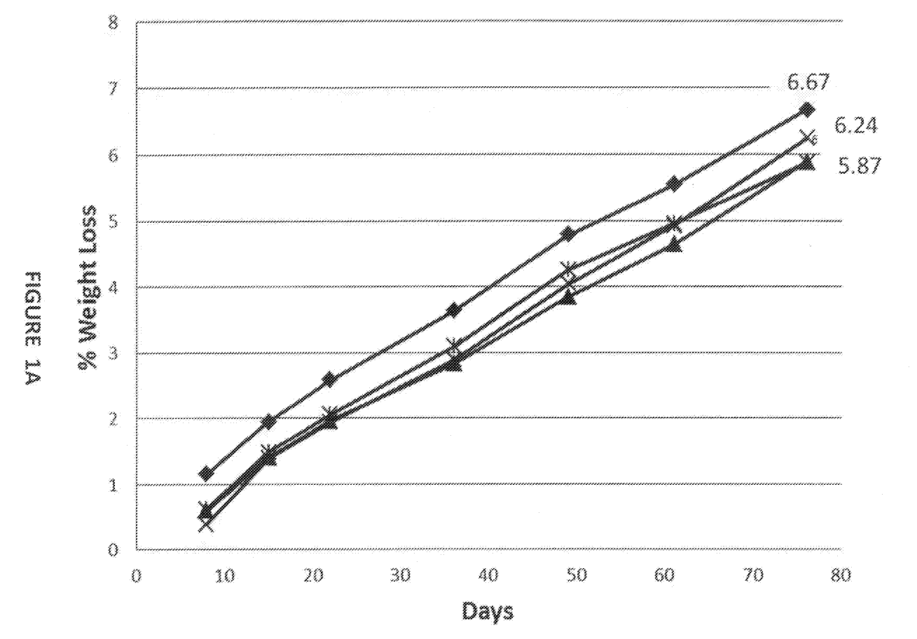

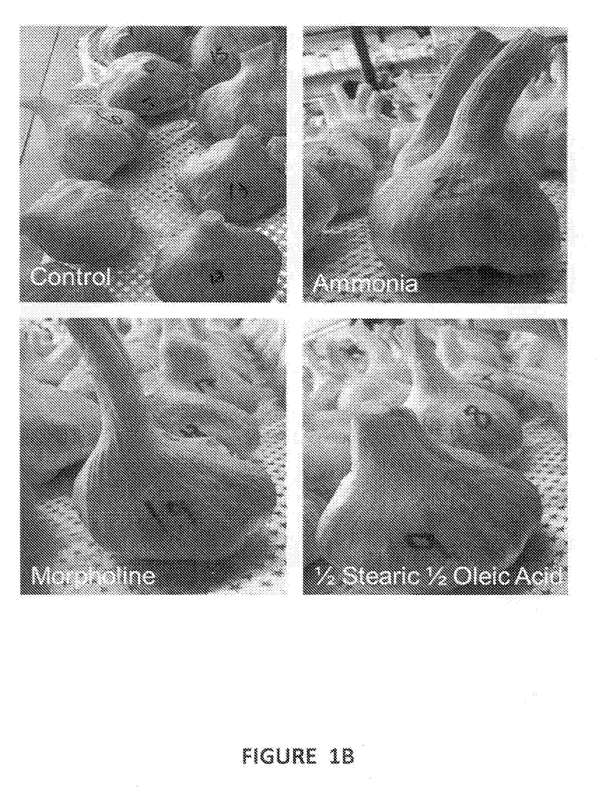

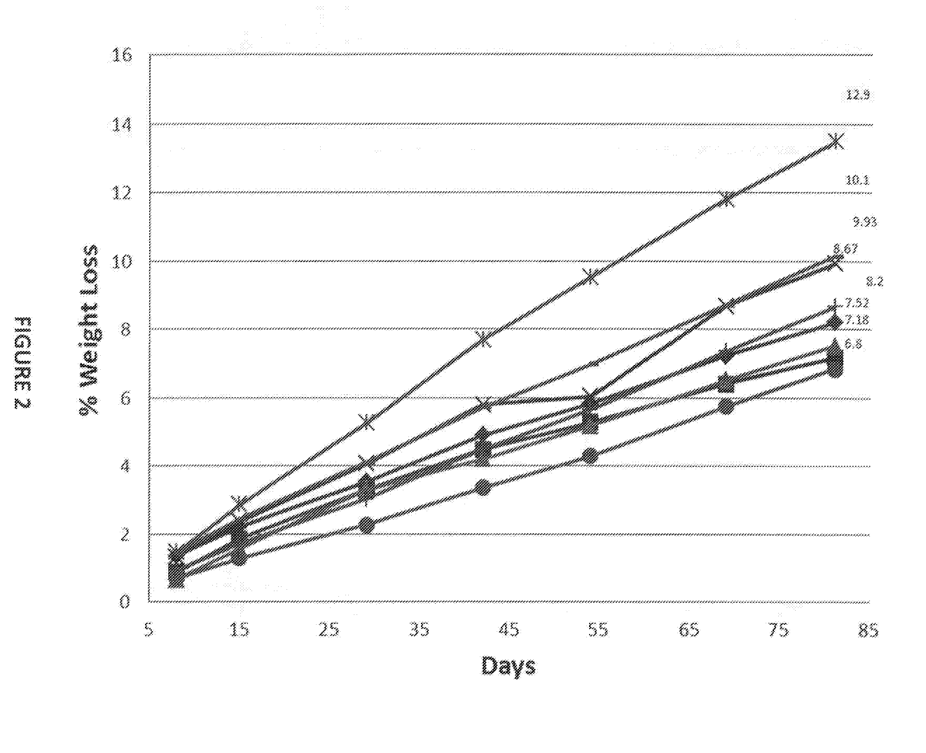

To test the effect of morpholine replacement in the coating formulation with ammonia, control garlic bulbs were left uncoated and the change in their fresh weight was compared with that of garlic bulbs coated with Formulations #1-#3 detailed in Table 1. The bulbs' weight loss was followed for about three months and the data presented in FIG. 1A, shows clearly that coating with either of Formulations #1-#3 resulted in reduced bulbs' weight losses by about 12% compared to the non-coated bulbs. The experiment teaches that 0.25% morpholine (Formulation #1) can be replaced with 0.3% ammonia (Formulation #2), and that 50% of the oleic acid can be replaced with stearic acid (Formulation #3), with little effect on the formulations' efficacy.

It is therefore concluded that when weight loss reduction is concerned, morpholine and ammonia perform as equivalent alkaline components, and that oleic acid and steric acid perform as equivalent fatty acids, and that the replacement of morpholine with ammonia had essentially no effect on the coating efficiency of garlic bulbs. It is important to note that all coatings produced by Formulations #1-#3 eventually came off and fall away from the garlic bulbs' tunics, and that Formulation #3 produced the least sticky/oily coat than the others.

### Example 3

### Weight Loss—Effect of Wax and Ammonia Content

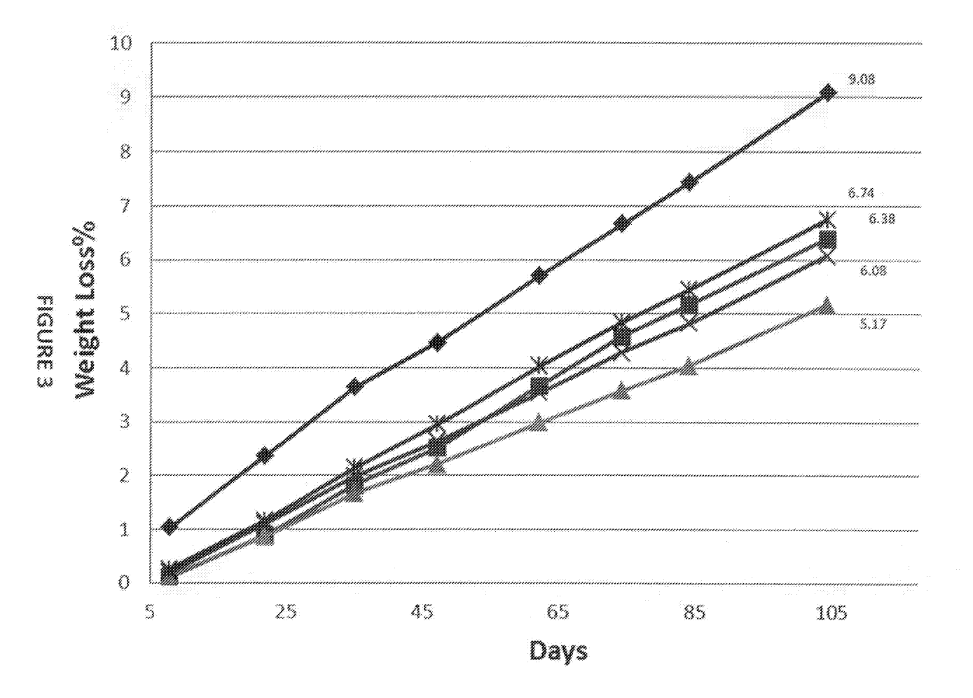

To test the effect of different beeswax and ammonia concentrations on coating Formulations' ability to slow down weight loss of coated produce (with or without β-sitosterol), garlic bulbs were left uncoated, or were coated with Formulations #2 and #4-#8 detailed in Table 1 (all with a wax:ammonia 2:3 weight ratio), and the bulbs' weight loss was followed for about three months. The data presented in FIG. 2 teaches that 0.2% beeswax and 0.3% ammonia effectively slow down the bulb's weight loss for up to about 17% compared to uncoated bulbs (Formulations #2 and #7), and that increasing said concentrations to 1% and 1.5%, respectively, necessitates the use of β-sitosterol to retain efficacy (Formulation #4). Further increasing the concentrations of wax and ammonia has a negative effect and in fact increases the bulb's weight loss (Formulations #5, #6 and #8).

Interpreted together with the experimental data provided in Example 1, it is concluded that coating formulations comprising ammonia instead of morpholine are of limited value and potency, as they are limited to low concentrations of wax and ammonia, and decrease garlic weight loss during storage by only 17%.

### Example 4

### Weight Loss—Comparison of Ammonia with Other Alkaline Components

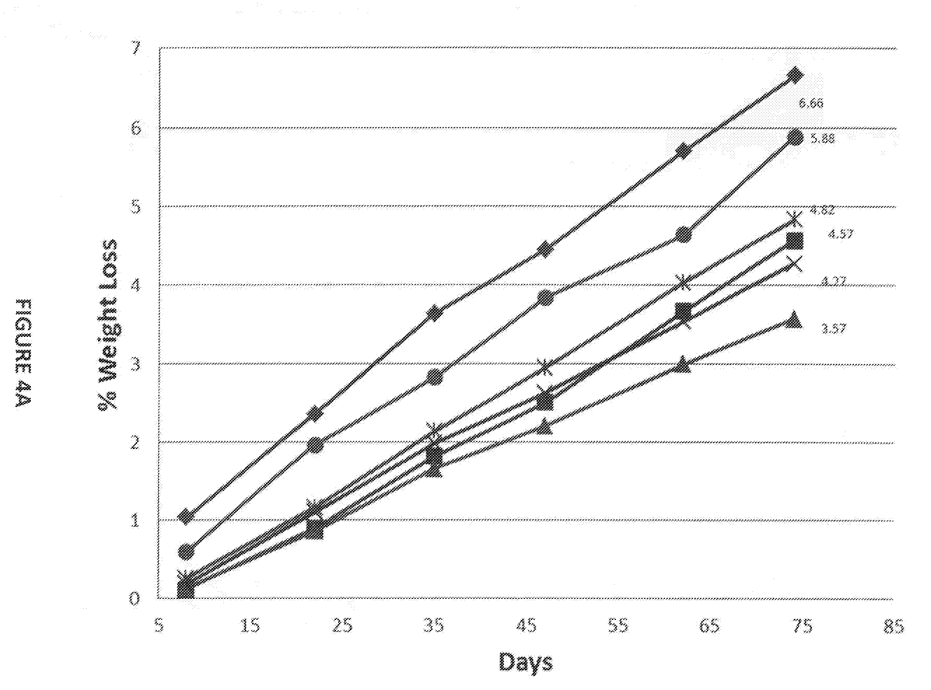

Since replacing morpholine with ammonia does not produce any substantially improved coating Formulations as demonstrated in Example 3, the effect of other alkaline components such as NaOH, KOH and Na₂CO₃ was also tested. To test the potency of said alkaline components in coating Formulations, garlic bulbs were left uncoated, or were coated with Formulations #2 and #9-#11 detailed in Table 1, and the temporal bulbs' weight loss in storage was followed for about three and a half months (all coating solutions were adjusted to pH 7.5). The data presented in FIG. 3 demonstrates that ammonia-based and sodium carbonate-based formulations (Formulations #2 and #11, respectively) reduced the weight loss of the coated bulbs' by about 30% compared to uncoated bulbs. However, Formulations #9 and #10 comprising NaOH and KOH, respectively, further reduced the weight loss of the coated bulbs' in storage by about 13% and 3%, respectively. Compared to Formulation #2, Formulations #9 and #10 were 43% and 33% more effective in reduced the coated bulbs' weight loss.

It is therefore evident that the use of an inorganic alkaline components such as an alkali metal salts or an alkaline earth metal salts instead of morpholine or any similar amine containing alkaline components in coating formulations for edible produce gives way to more efficacious and safer coating formulations.

### Example 5

### Weight Loss—Comparison of Morpholine with Other Alkaline Components

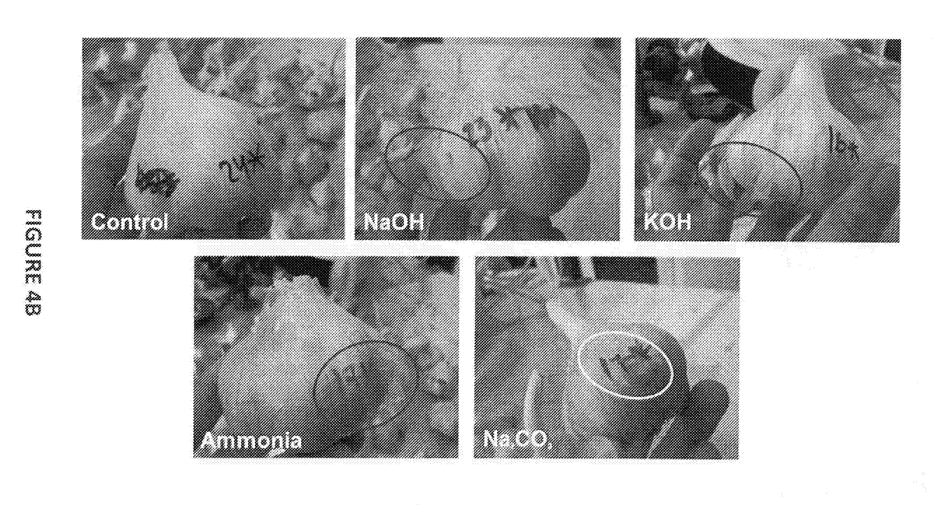

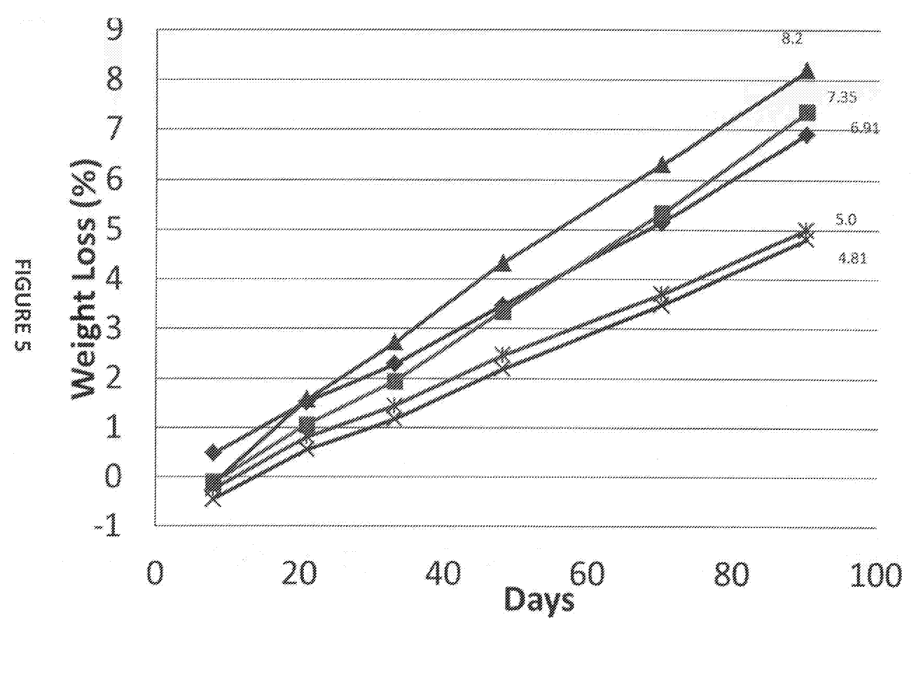

Further to the experimental data presented in Example 4, Formulations #2 and #9-#11 were directly compared with Formulation #1, which comprises morpholine. To test the potency of said formulations, garlic bulbs were left uncoated, or were coated with Formulations #1, #2 or #9-#11 detailed in Table 1, and the temporal bulbs' weight loss was followed for about two and a half months. The data presented in FIG. 4A is similar to the data shown in FIG. 3, with the exception that Formulation #1, which comprises morpholine as an alkaline component, is clearly inferior to all other Formulations comprising alternative alkaline components. As evident in FIG. 4B, Formulation #11 comprising Na₂CO₃ as alkaline component, produced a coat which remained attached longer and stronger to the treated plants' surface than the coatings produced by other Formulations used, albeit said coating visibly stained the garlic bulb.

It is therefore evident that the use of edible alkaline components instead of morpholine allows not only for reduced health hazards of the coating materials but to increase the protective efficiency of the coating.

### Example 6

### Weight Loss—Comparison Between Ammonia and KOH as an Alkaline Component

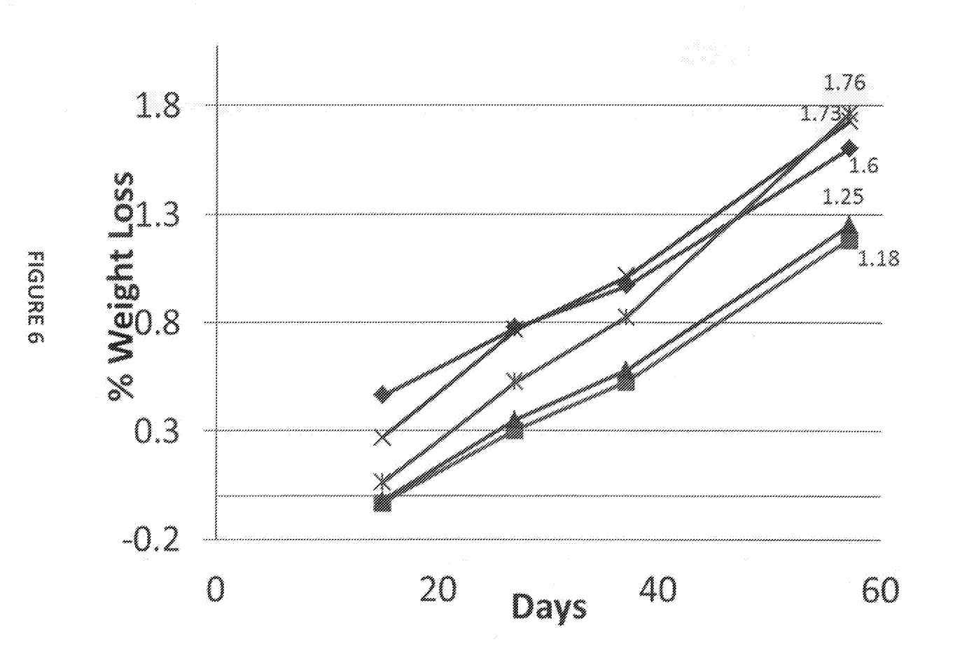

The experimental data provided in Examples 4 and 5 suggests that while the NaOH-based coating Formulation (Formulation #9) is far superior to the ammonia-based coating formulation (Formulation #2), the KOH-based coating formulation (Formulation #10) provides only modest improvement over ammonia containing formulation. This data is slightly counter-intuitive since chemically speaking both NaOH and KOH have very similar attributes. To explore this discrepancy, garlic bulbs were left uncoated, or were coated with Formulations #12-#14 described in Table 1, and the temporal bulbs' weight loss was followed for about three months. The data presented in FIG. 5 teaches that while ammonia-based formulation (Formulation #12) was ineffective in slowing down weight loss, KOH-based formulations were effective in reducing weight loss of the coated bulbs' by about 31% compared to uncoated bulbs (Formulation #14) or by about 28% when sitosterol was excluded (Formulation #13).

It is therefore evident that the use of KOH as an alkaline component in coating Formulations for edible produce is of comparable efficacy to NaOH-based formulations. The fact that Formulation #10 in Examples 4 and 5 did not perform as well as formulations #13 and #14 tested herein may be attributed to the significant difference in beeswax content in said formulations, wherein Formulations #13 and #14 comprise 1% beeswax, which is five times the beeswax content in Formulation #10 (0.2%).

### Example 7

### Weight Loss—Comparison Between Different Fatty Acids

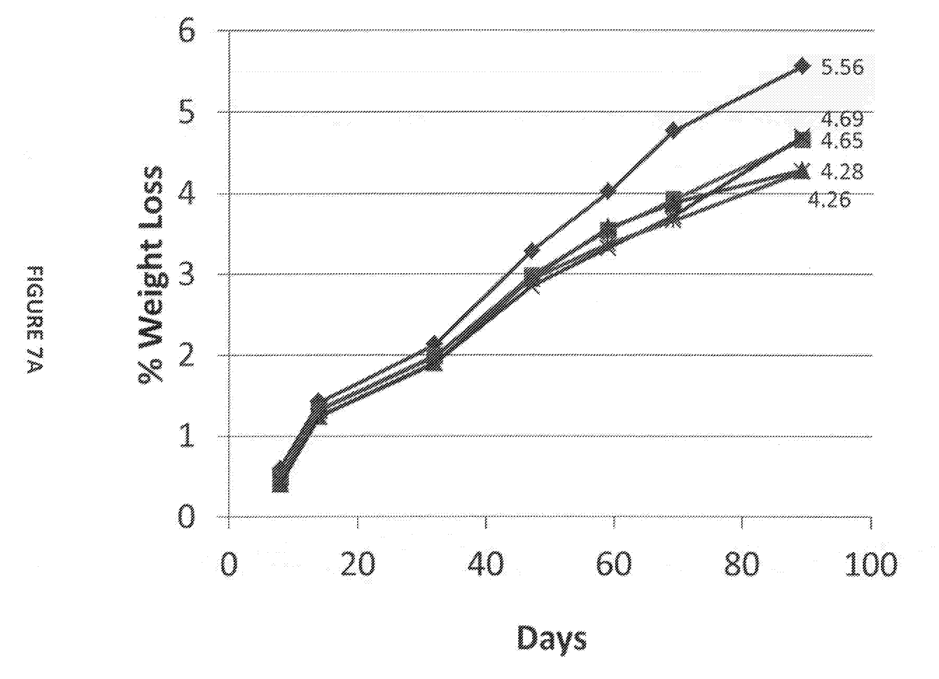

The incorporation of fatty acids in the coating formulations provided herein is essential for dissolving the edible wax component, e.g. beeswax. To test the potency of different fatty acids in coating formulations, garlic bulbs were left uncoated, or were coated with Formulations #10 and #15-#17 detailed in Table 1, and the temporal bulbs' weight loss was followed for about two months. The data presented in FIG. 6 shows that Formulations #10 and #15 (comprising 1.8% oleic acid or a combination of 0.9% oleic acid and 0.9% stearic acid, respectively) slowed down the coated bulbs' weight loss by about 27% and about 22%, respectively, compared to uncoated bulbs. In addition, Formulation #17 (comprising 0.9% oleic acid, 0.45% stearic acid and 0.45% palmitic acid) significantly reduced the coated bulbs' weight loss.

It is therefore evident that while the use of a fatty acid such as oleic acid is mandatory to promote wax solubilization, the use of fatty acids combinations is also applicable and may be favorable, for example when such combinations are preferred in view of certain technical considerations.

### Example 8

### Weight Loss—Comparison Between Ammonia and Other Alkaline Components

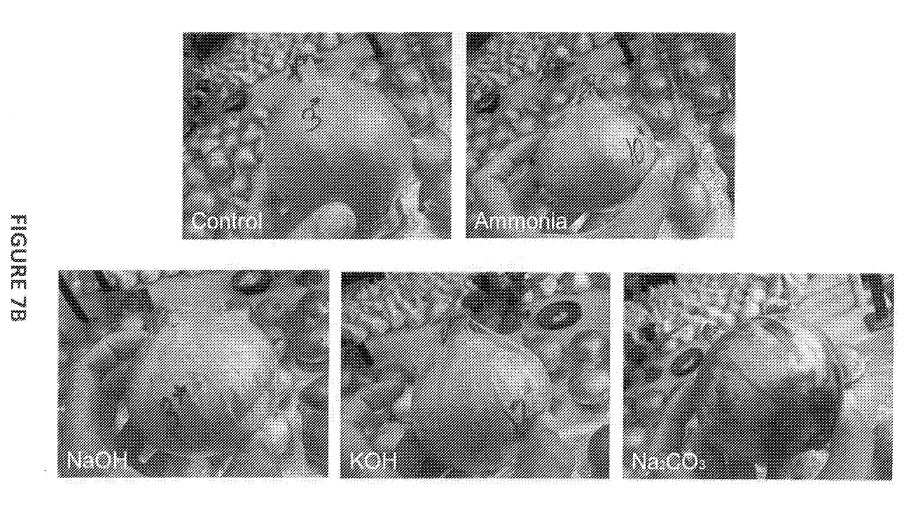

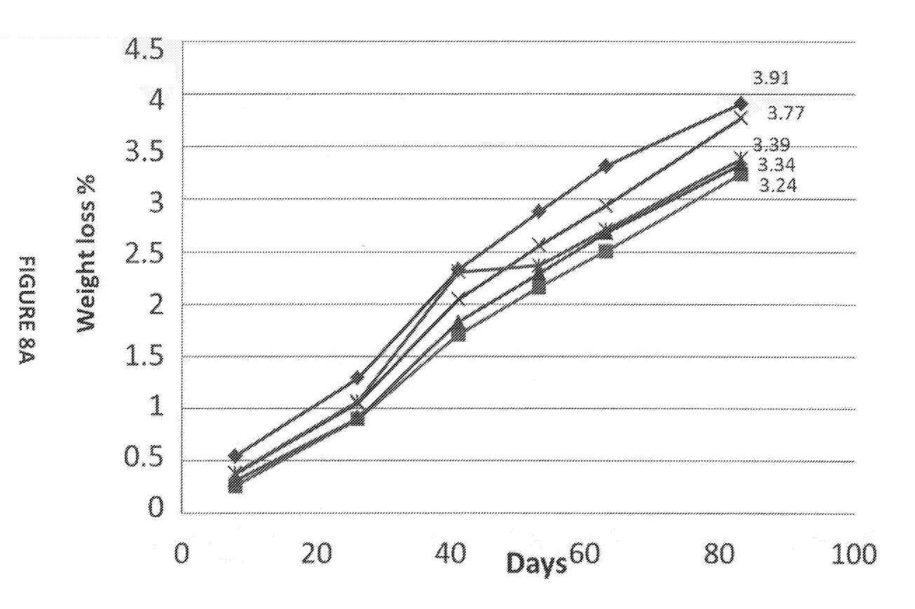

Coating Formulations #2 and #9-#11 were also tested for their effect on loss of weight in stored bulb onions. To test the potency of said Formulations, bulb onions were left uncoated, or were coated with Formulations #2 and #9-#11 detailed in Table 1, and the temporal bulbs' weight loss was followed for about three months. The data presented in FIG. 7A shows that all Formulations were substantially effective, reducing the bulb onions' weight loss by about 16% (Formulations #2 and #10 comprising ammonia and KOH, respectively) to about 24% (Formulations #9 and #11 comprising NaOH and Na₂CO₃, respectively).

It is therefore evident, as in Example 4, that the use of an inorganic salt such as an alkali metal salt or an alkaline earth metal salt instead of morpholine or any similar amine containing alkaline components in coating formulations for edible produce gives way to more efficacious and safer coating formulations.

### Example 9

### Weight Loss—the Effect of Wax and Sitosterol Content

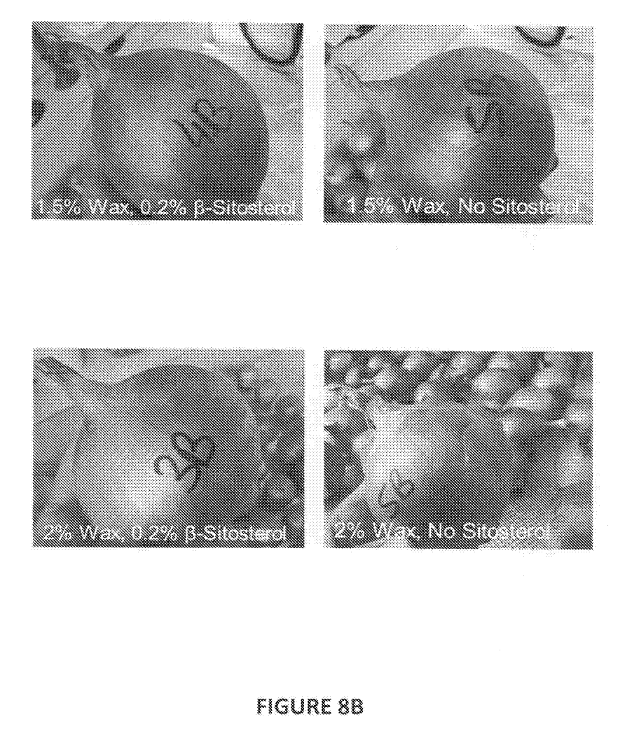

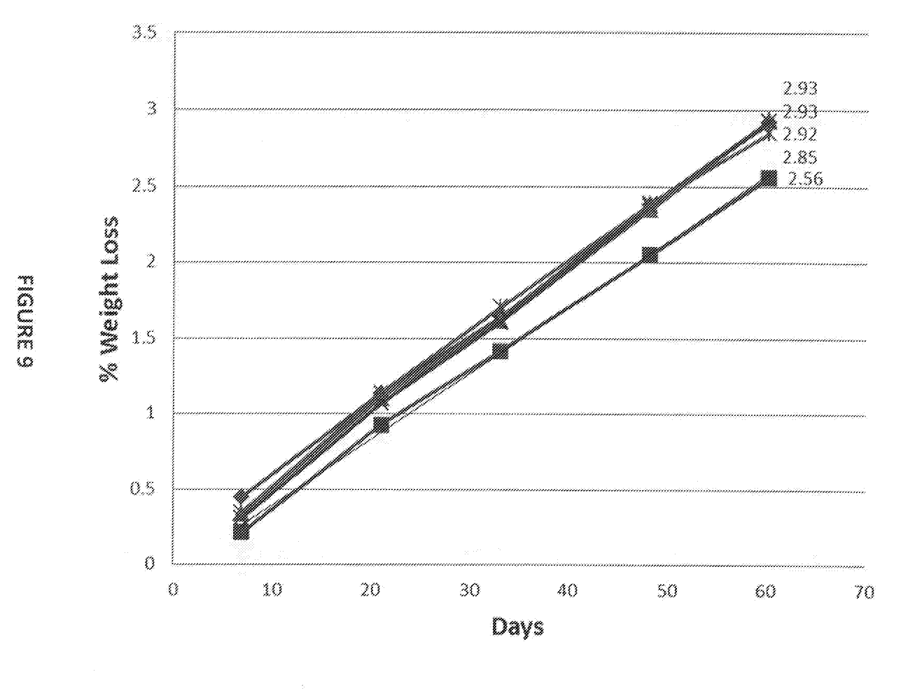

To test the effect of different beeswax and β-sitosterol concentrations on coating formulations ability to slow down weight loss of coated produce, bulb onions were left uncoated, or were coated with Formulations #18-#21 detailed in Table 1, and the temporal onions' weight loss was followed for about three months. The data presented in FIG. 8 shows that a formulation of 2% beeswax and 0.2% β-sitosterol effectively slows down the onions' weight loss by about 18% compared to uncoated onions (Formulation #18), and that lowering the wax's concentrations to 1.5% (Formulation #20), exclusion of β-sitosterol (Formulation #19) or both (Formulation #21) have a negative effect on the formulations' efficacy. It should be noted that all formulations produced oily coats, which adhered well to the onions, wherein the coat produced by Formulation #20 was less oily at touch.

Interpreted together with the experimental data provided in Example 6, it is concluded that coating formulations comprising both beeswax and β-sitosterol significantly and effectively slow down onions' weight loss.

### Example 10

### Weight Loss—Comparison Between Ammonia and KOH as an Alkaline Component

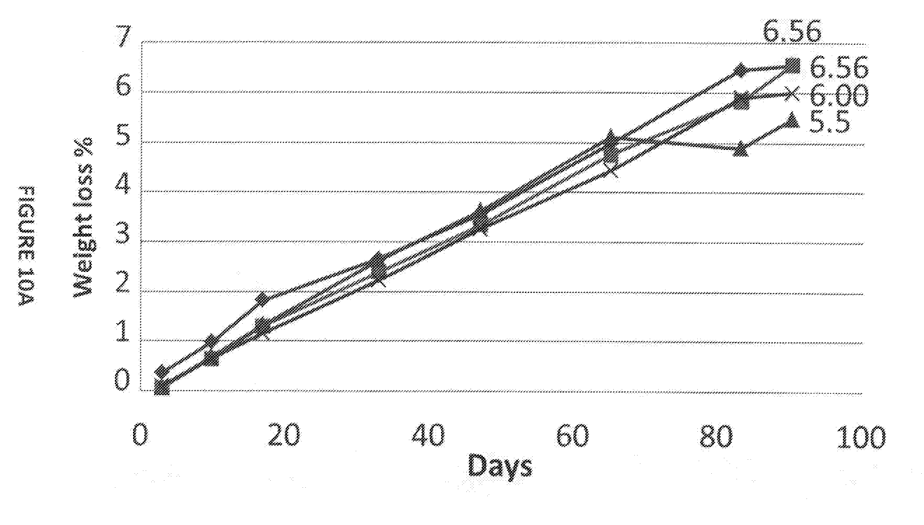

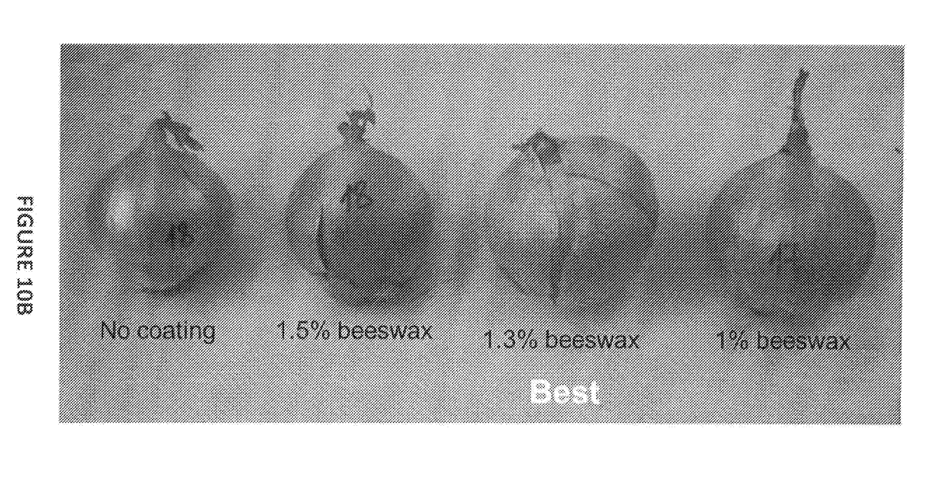

To test the efficacy of ammonia and KOH as alkaline components in coating Formulations for bulb onions, bulbs were left uncoated, or were coated with Formulations #12, #13 and #22 detailed in Table 1, and the temporal bulb onions' weight loss was followed for about two months. The data presented in FIG. 9 shows that while an ammonia-based Formulation comprising sitosterol was effective in slowing down weight loss (Formulation #22), a sitosterol-free ammonia-based formulation was not effective (Formulation #12). Surprisingly, Formulation #13, comprising sitosterol and KOH, was not effective as well, which stands in contrast to its efficacy as demonstrated in Example 6 above.

### Example 11

### Weight Loss—the Effect of Wax and Sitosterol Content

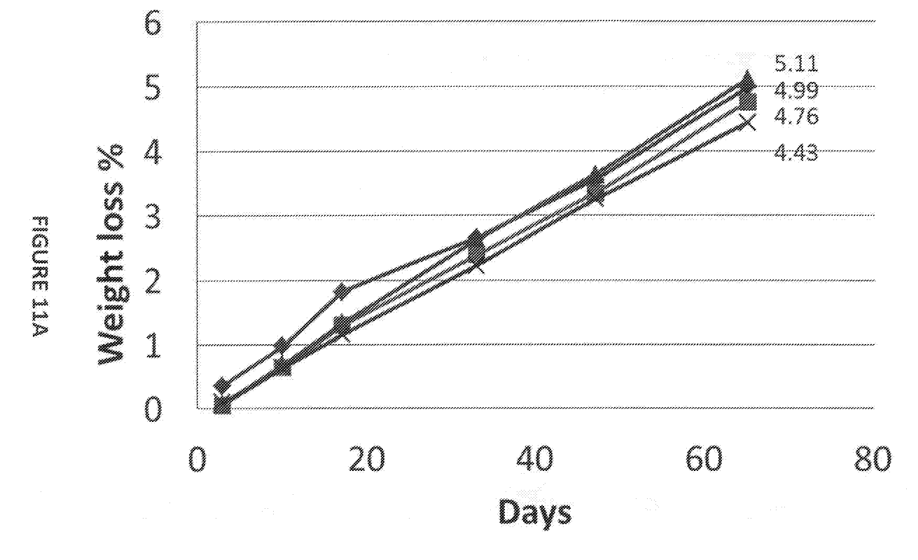

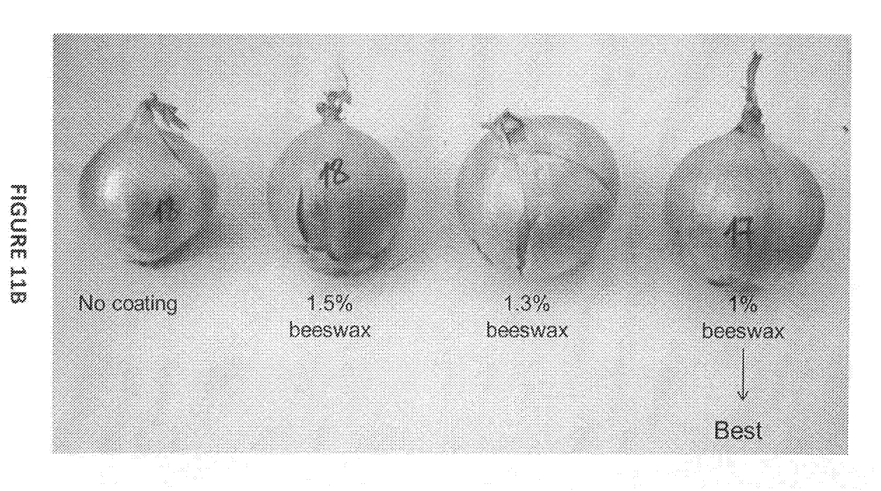

To further test the effect of different beeswax and β-sitosterol concentrations on coating Formulations ability to slow down weight loss of coated produce, bulb onions were left uncoated, or were coated (by dipping) with Formulations #21, #23 and #24 detailed in Table 1, and the temporal bulb onions' weight loss was followed for about three months. The data presented in FIG. 10A teaches that a sitosterol-free formulation comprising 1.5% and 1% beeswax effectively slowed down the onions' weight loss for up to about 9% compared to uncoated onions (Formulations #21 and #24, respectively), while a formulation comprising a beeswax's content of 1.3% with 0.2% sitosterol has an increased efficacy (Formulation #23).

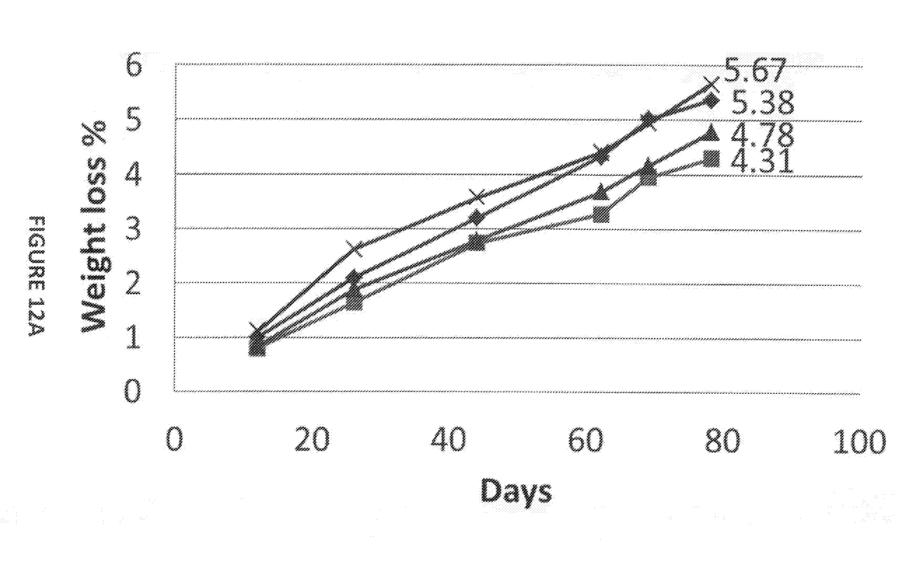

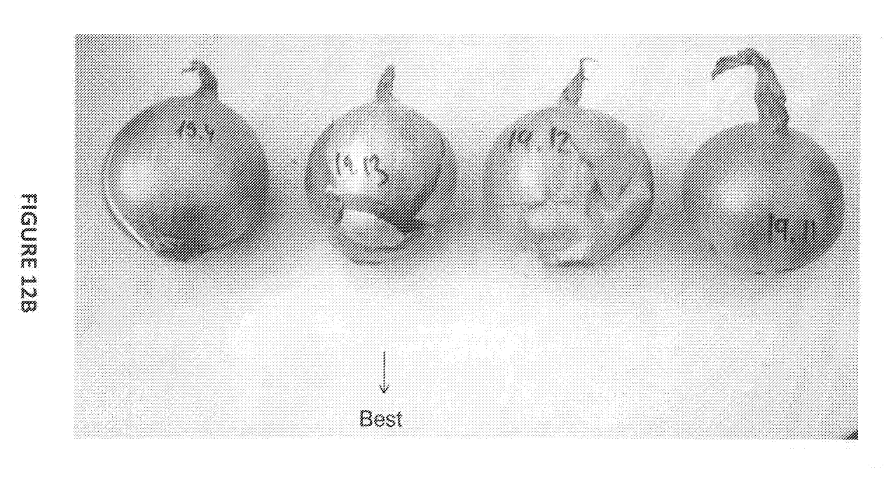

In repeating the above experiment, this time following the temporal bulb onions' weight loss for about two months, Formulation #24 (comprising 1% beeswax and no sitosterol) was found most effective (see FIG. 11A). It is therefore concluded that coating Formulations comprising 1%-1.5% beeswax effectively slow down onions' weight loss.

### Example 12

### Weight Loss—the Effect of Wax Content

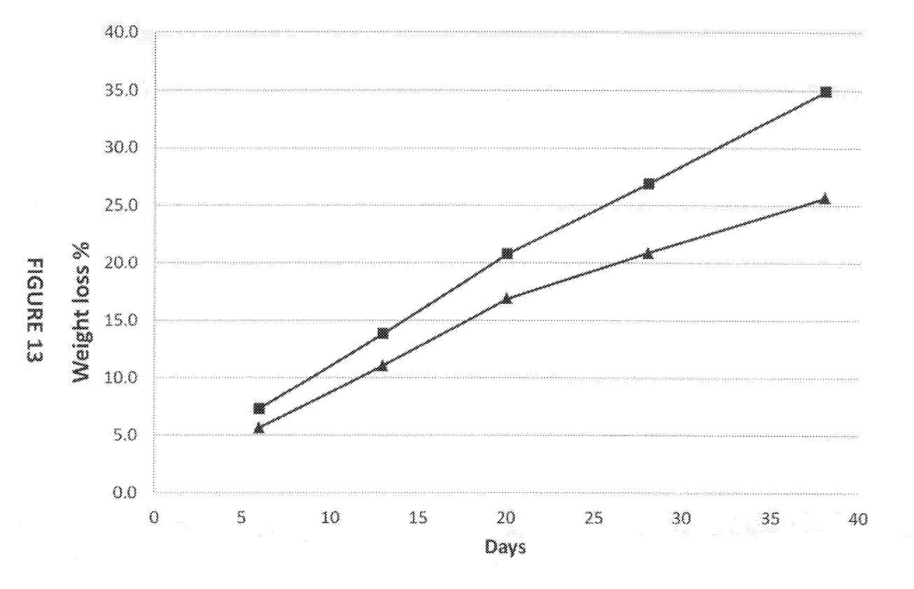

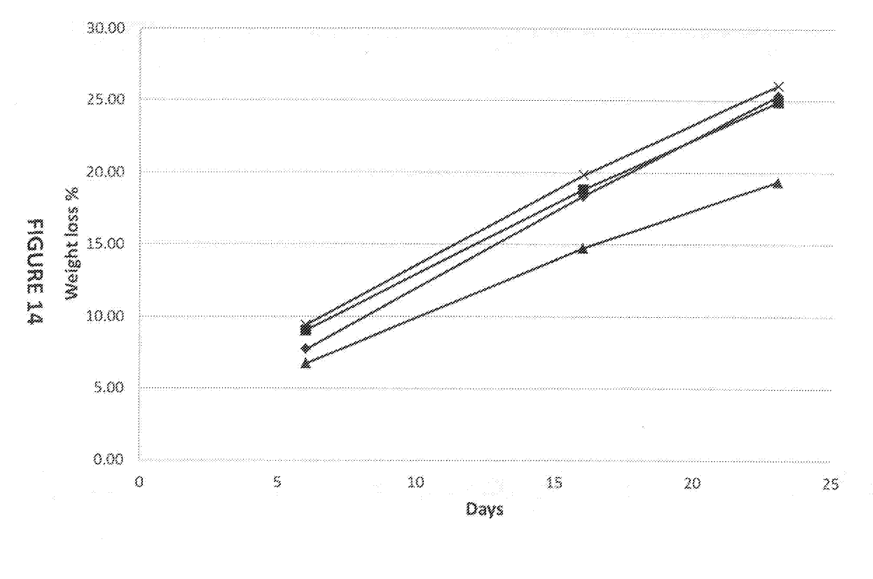

To further explore the effect of beeswax concentration on coating formulations ability to slow down weight loss of coated produce, bulb onions were left uncoated, or were coated (by dipping) with Formulations #21, #24 and #25 detailed in Table 1, and the temporal bulb onions' weight loss was followed for about three months. The data presented in FIG. 12A teaches again that the formulations comprising 1.5% and 1% beeswax effectively slow down the bulb onions' weight loss for up to about 20% compared to non-coated onions (Formulations #21 and #24, respectively), while a formulation comprising a beeswax's content of 0.5% has lower efficacy (Formulation #23).

It again becomes apparent that coating formulations comprising 1%-1.5% beeswax effectively slow down onions' weight loss.

### Example 13

### Coating of Peppers, Eggplants and Tomatoes

### Materials and Methods

The coating compositions used throughout the experiments of Examples 14-21 are summarized in Tables 3 and 4, below.

TABLE 3
Compositions.

| # | LBG* | CMC* | GG* | BW* | OA* | KOH | Mor* |
|---|---|---|---|---|---|---|---|
| 26 | 0.5% | | | 15% | 1.8% | 0.4% | |
| 27 | 0.5% | | | 15% | 1.8% | 0.54% | |
| 28 | 0.5% | | | 12% | 1.8% | 0.54% | |
| 29 | 0.5% | | | 15% | 1.44% | 0.54% | |
| 30 | | 1% | | 15% | 1.8% | 0.54% | |
| 31 | | | 0.5% | 15% | 1.8% | 0.54% | |
| 32 | | | 0.5% | 17.5% | 1.8% | 0.54% | |
| 33 | 0.5% | | | 15% | 1.8% | | 1.5% |

The percentages are by weight (% w/w).
*LBG—locust bean gum;
CMC—carboxymethyl cellulose;
GG—guar gum;
BW—beeswax;
OA—oleic acid;
Mor—morpholine.

TABLE 4
Compositions per Example

| | Example | | | | | | |
|---|---|---|---|---|---|---|---|
| Composition | 14 | 15 | 16 | 17 | 18 | 19 | 20 |
| 26 | + | | | | | | |
| 27 | | + | + | + | + | + | + |
| 28 | | + | | | | | |
| 29 | | + | | | | | |
| 30 | | | + | | | + | |
| 31 | | | | + | | | + |
| 32 | | | | + | | | + |
| 33 | | | | | + | | |

### Formulation Preparation and Application

A hydrocolloid (e.g. locust bean gum, guar gum or carboxymethyl cellulose) was dissolved in distilled water preheated to 90° C., followed by blending/homogenization of a mixture of a fatty acid (e.g. oleic acid, stearic acid, palmitic acid or β-sitosterol) and an alkaline component (e.g. KOH, NaOH, ammonia, morpholine or Na₂CO₃). The last step included addition of the above mixture to the melted wax. The final mixture was homogenized for 3 min at 16,000 rpm and then cooled to room temperature. A layer of said mixture was applied to peppers eggplants, and/or tomatoes.

### Weight Loss Measurement

The weight loss measurements for red peppers and eggplants were carried out as described in Example 1.

### Example 14

### The Effect of KOH on Peppers Weight Loss

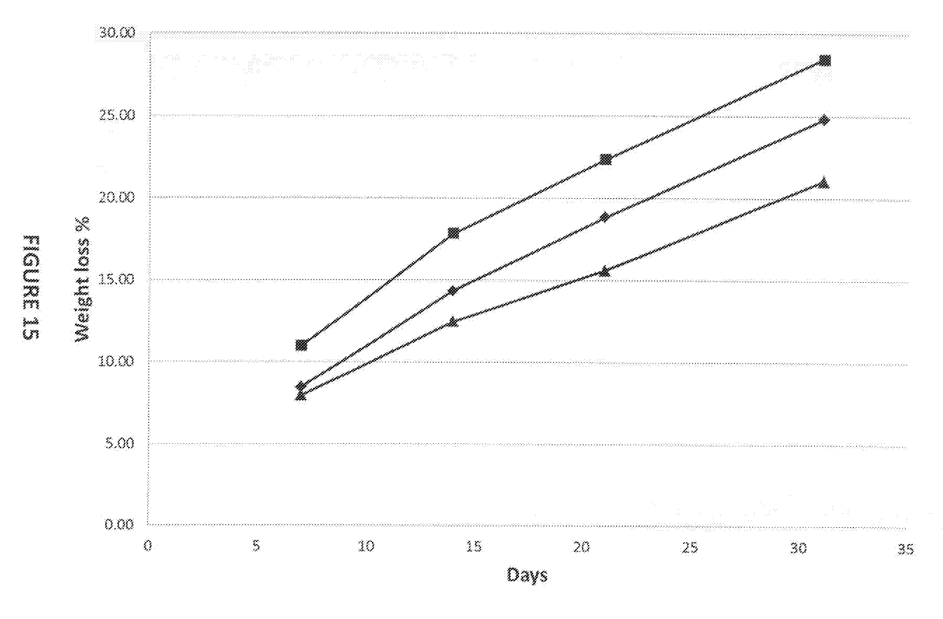

To test the effect of KOH in the coating formulation, control red peppers were left uncoated and the change in their fresh weight was compared with that of peppers coated with Formulation #26 as detailed in Table 3. The peppers' weight loss at ambient storage conditions was followed for about one and half month. As shown in FIG. 13, the coating with Formulation #26 comprising KOH resulted in reduced peppers' weight loss by about 9% compared to the non-coated peppers. Thus, the use of inorganic alkaline components such as an alkali metal in coating formulations for peppers gives way to more efficacious and safer coating formulations.

### Example 15

### Weight Loss—Effect of Wax and Fatty Acid Content

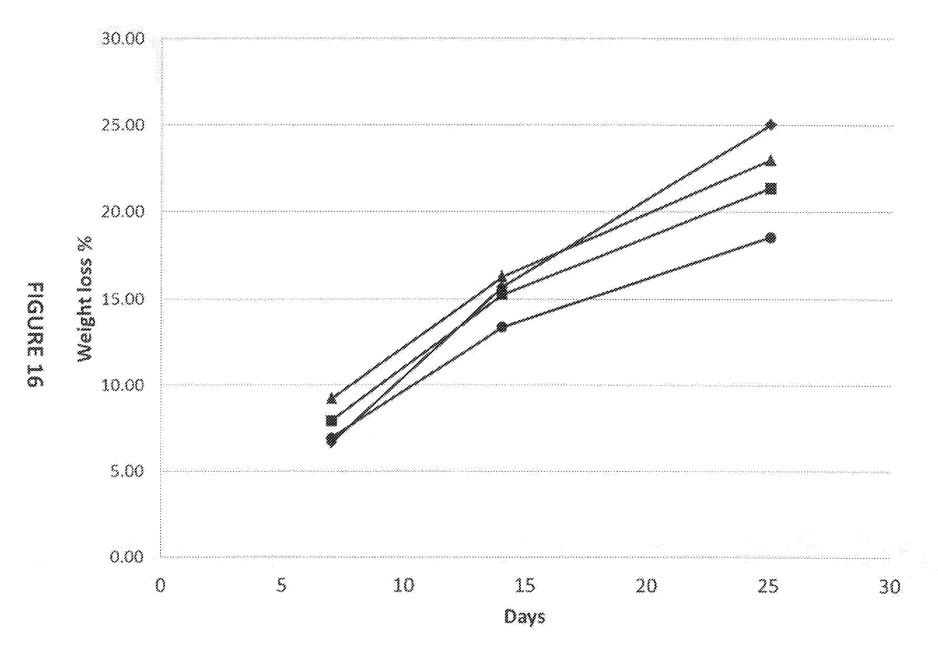

The effect of different beeswax and oleic acid concentrations on coating formulations' ability to slow down weight loss of coated produce was examined Red peppers were left uncoated, or were coated with Formulations #27, #28 and #29 detailed in Table 3. The peppers' weight losses were followed for about three and a half weeks. The data presented in FIG. 14 teaches that Formulation #27 (comprising 15% beeswax and 1.8% oleic acid) was found most effective in reducing the coated pepper's weight loss as compared to Formulation #28 and uncoated peppers. The measured pepper's weight loss was about 6% compared to uncoated peppers. Reducing the oleic acid concentrations to 1.44% (Formulation #29) had no effect on the weight loss of coated peppers.

### Example 16

### Weight Loss—Comparison Between Different Hydrocolloid Polymers

The effect of two different hydrocolloid polymers on coating formulations ability to slow down weight loss of coated produce was tested. Red peppers were left uncoated, or were coated with Formulations #27 and #30 detailed in Table 3. The temporal peppers' weight loss was followed for about one month. The data presented in FIG. 15 shows that 0.5% locust bean gum (LBG; Formulation #2) more effectively slowed down the peppers' weight loss compared to 1% carboxymethyl cellulose (CMC) coated peppers (Formulation #30).

### Example 17

### Weight Loss—Comparison Between Different Hydrocolloid Polymers

Following Example 16, the effect of another hydrocolloid polymer in the coating formulations was tested for its effect on weight loss of stored peppers. Red peppers were left uncoated, or were coated with Formulations #27, #31 and #32 detailed in Table 3. The peppers' weight loss was followed for about three and a half weeks. The data presented in FIG. 16 teaches that Formulation #32 (comprising 0.5% guar gum and 17.5% beeswax) compared to Formulations #27 and #31 (comprising 0.5% locust bean gum or 0.5% guar gum in combination with 15% beeswax, respectively) was more effective in reducing the coated the peppers' weight loss.

### Example 18

### Weight Loss—Comparison Between Morpholine and KOH as an Alkaline Component

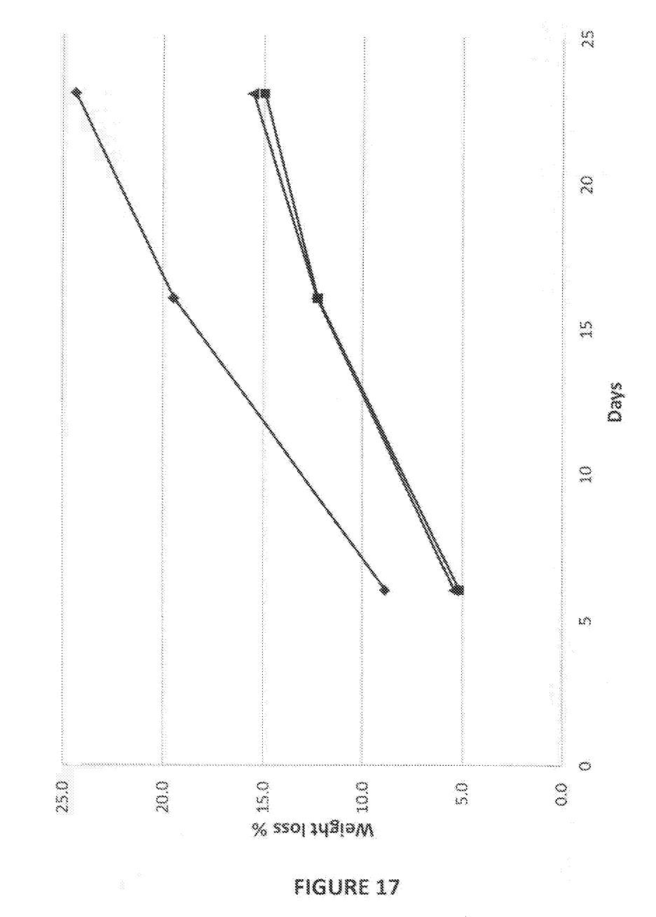

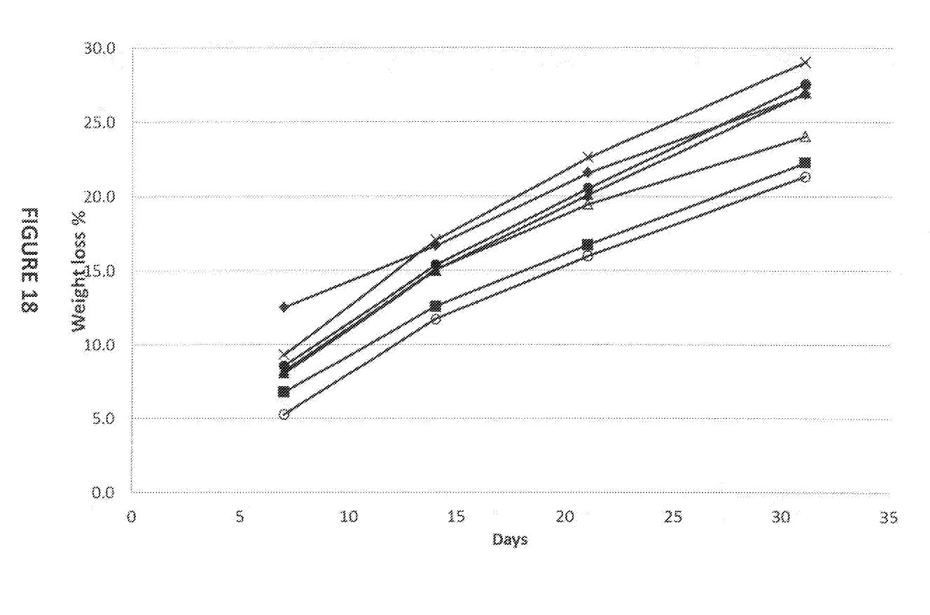

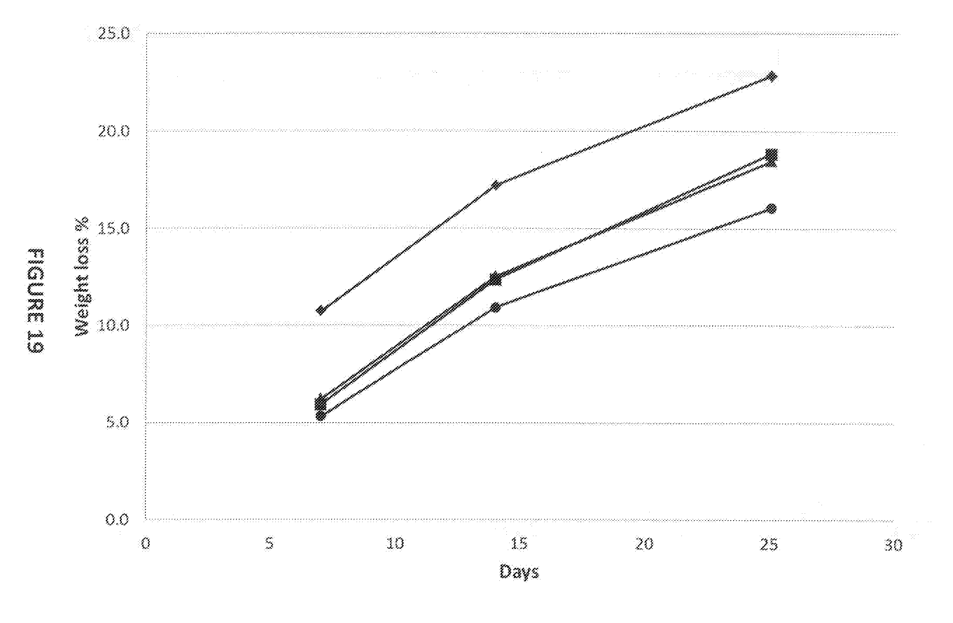

The efficacy of morpholine and KOH as alkaline components in coating formulations for eggplants was tested. Eggplants were left uncoated, or were coated with Formulations #27, and #33 detailed in Table 3, and the eggplants' weight loss was followed for about three and a half weeks. Storage conditions were ambient. The data presented in FIG. 17 shows that a KOH-based formulation (Formulation #27) was as effective in slowing down weight loss as morpholine-based formulation (Formulation #33).

### Example 19

### Weight Loss—Comparison Between Different Hydrocolloid Polymers

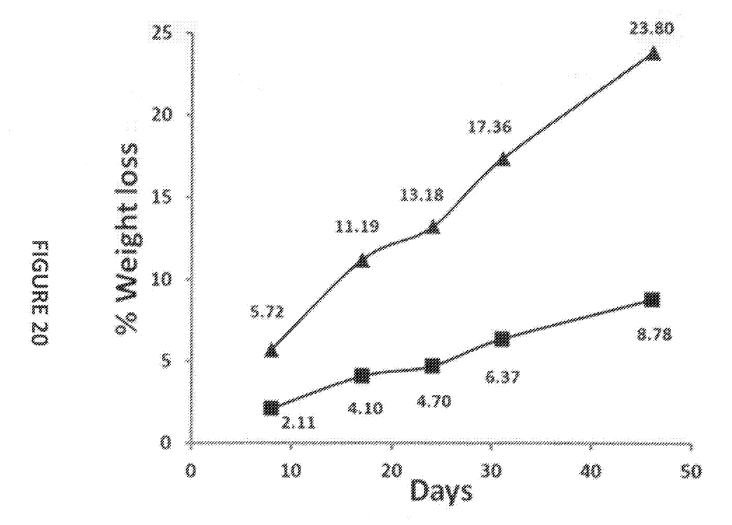

The effect of two different hydrocolloid polymers on coating formulations ability to slow down weight loss of coated produce was tested. Eggplants were left uncoated, or were coated with Formulations #27 and #30 detailed in Table 3. The eggplants' weight loss was followed for about one month. In addition, the weight loss of the pedicel alone was examined The data presented in FIG. 18 shows that 0.5% locust bean gum (LBG; Formulation #27) slowed down more effectively the eggplants' weight loss compared to 1% carboxymethyl cellulose (CMC) (Formulation #30). This effect was observed on the whole eggplant fruit as well as on the pedicel alone and the eggplant without a pedicel.

### Example 20

### Weight Loss—Comparison Between Different Hydrocolloid Polymers

Following Example 19, the effect of another hydrocolloid polymer in the coating formulations was tested for its ability to slow down the weight loss of coated produce. Eggplants were left uncoated, or were coated with Formulations #27, #31 and #32 detailed in Table 3. The eggplants' weight loss was followed for about three and a half weeks. The data presented in FIG. 19 teaches that 0.5% locust bean gum (LBG; Formulation #27) slowed down the eggplants' weight loss more effectively as compared to 0.5% guar gum (GG) (Formulation #31). This superiority of LBG over GG was seen even when the beeswax concentrations in the GG-based formulation (Formulation #32) was raised to 2.5%.

### Example 21

### The Effect of KOH on Tomatoes Weight Loss

To test the effect of KOH in the coating formulation on stored tomatoes, control tomatoes were left uncoated and the change in their fresh weight was compared with that of tomatoes coated with Formulation #27 as detailed in Table 3. The tomatoes' weight loss at ambient storage conditions was followed for about one and half months. As shown in FIG. 20, the coating with Formulation #27 comprising KOH resulted in reduced tomatoes' weight loss by about 15% compared to the non-coated tomatoes. Thus, the use of inorganic alkaline components such as an alkali metal in coating formulations for tomatoes gives way to more efficacious and safer coating formulations.

While the present invention has been particularly described, persons skilled in the art will appreciate that many variations and modifications can be made. Therefore, the invention is not to be construed as restricted to the particularly described embodiments, rather the scope, spirit and concept of the invention will be more readily understood by reference to the claims which follow.

1.-35. (canceled)

36. A composition for coating a postharvest plant matter, the composition comprising:
i. a hydrocolloid polymer in a weight percent ranging from about 0.5% to about 5% of the total weight of the wet composition;
ii. an edible wax;
iii. a fatty acid;
iv. water; and
v. an edible alkaline component, which is an inorganic salt;
the composition being essentially free of morpholine and ammonia,
wherein the edible alkaline component enables formation of a homogeneous emulsion without any additional emulsifier and wherein the composition is essentially free of any additional emulsifier other than the edible alkaline component.

37. The composition according to claim 36, wherein the edible alkaline component is essentially free of amines.

38. The composition according to claim 36, wherein the edible alkaline component is an alkali metal salt or an alkaline earth metal salt.

39. The composition according to claim 38, wherein the edible alkaline component is selected from the group consisting of sodium hydroxide, potassium hydroxide, sodium carbonate, potassium carbonate, sodium bicarbonate, potassium bicarbonate and any combination thereof.

40. The composition according to claim 36, wherein the edible alkaline component is present in a weight percent ranging from about 0.05% to about 2% of the total weight of the wet composition or in a weight percent ranging from about 1% to about 30% of the total weight of the dry composition.

41. The composition according to claim 36, wherein the hydrocolloid polymer is selected from the group consisting of alginate, agar, agarose, gelatin, low methoxy pectin (LMP), chitosan, gellan, carrageenan, locust bean gum (LBG), guar gum and any combination thereof.

42. The composition according to claim 36, comprising the hydrocolloid polymer in a weight percent ranging from about 20% to about 60% of the total weight of the dry composition.

43. The composition according to claim 36, wherein the edible wax is selected from the group consisting of beeswax, carnauba wax, candelilla wax, alpha wax, montan wax, rice-bran wax, Japan wax and any combination thereof.

44. The composition according to claim 36, comprising the edible wax in a weight percent ranging from about 0.1% to about 50% of the total weight of the wet composition or in a weight percent ranging from about 2% to about 35% of the total weight of the dry composition.

45. The composition according to claim 36, wherein the fatty acid is selected from the group consisting of oleic acid, stearic acid, palmitic acid, lauric acid, myristic acid, behenic acid, isostearic acid and any combination thereof.

46. The composition according to claim 36, comprising the fatty acid in a weight percent ranging from about 0.01% to about 2% of the total weight of the wet composition or in a weight percent ranging from about 1% to about 40% of the total weight of the dry composition.

47. The composition according to claim 36, wherein the edible plant matter is selected from the group consisting of garlic, onions, shallots, eggplants, peppers and tomatoes.

48. The composition according to claim 47, wherein the edible plant matter is selected from garlic or onions.

49. The composition according to claim 36, further comprising an additional component selected from the group consisting of a natural compound isolated from the surface of said plant matter or a derivative thereof, a cross-linking agent, a gelation inducing agent, and any combination thereof.

50. The composition according to claim 36, comprising:
i. about 0.5%-5% (w/w) of hydrocolloid polymer;
ii. about 0.1%-5% (w/w) of edible wax;
iii. about 0.01%-2% (w/w) of fatty acid;
iv. about 83%-99% water; and
v. about 0.05%-2% (w/w) of edible alkaline component,
of the total weight of the wet composition.

51. The composition according to claim 50, wherein the hydrocolloid is alginate, the edible wax is beeswax and the fatty acid is oleic acid.

52. The composition according to claim 36, comprising:
i. about 20%-60% (w/w) of hydrocolloid polymer;
ii. about 2%-35% (w/w) of edible wax;
iii. about 1%-40% (w/w) of fatty acid;
iv. about 4%-30% water; and
v. about 1%-30% (w/w) of edible alkaline component,
of the total weight of the dry composition.

53. The composition according to claim 52, wherein the hydrocolloid is alginate, the edible wax is beeswax and the fatty acid is oleic acid.

54. A method for reducing the weight loss of a postharvest plant matter by providing an artificial coat, comprising the step of applying the composition of claim 36 to the surface of said plant matter, thereby forming a coating layer on the surface of said plant matter.

55. The method according to claim 54, further comprising the steps of:
i. allowing the excess composition to drip from the plant matter; and
ii. drying the coating of the plant matter,
iii. and, optionally, applying to the plant matter additional composition comprising a cross-linking or gelation-inducing agent.
